(19) United States
(12) Patent Application Publication
(10) Pub. No.: US 2011/0164527 A1
(43) Pub. Date: Jul. 7, 2011

(54) ENHANCED WIRELESS AD HOC COMMUNICATION TECHNIQUES

(76) Inventors: Rajesh K. Mishra, Westford, MA (US); Scott Y. Seidel, Fairfax, VA (US); Jeffrey E. Smith, Nashua, NH (US); Gregory Clark Copeland, Plano, TX (US)

(21) Appl. No.: 13/062,166

(22) PCT Filed: Sep. 4, 2009
(86) PCT No.: PCT/US09/56130

§ 371 Date: Mar. 3, 2011

Related U.S. Application Data
(63) Continuation-in-part of application No. 12/418,363, filed on Apr. 3, 2009.
(60) Provisional application No. 61/042,431, filed on Apr. 4, 2008.
(60) Provisional application No. 61/042,442, filed on Apr. 4, 2008.
(60) Provisional application No. 61/074,930, filed on Jun. 23, 2008.
(60) Provisional application No. 61/082,618, filed on Jul. 22, 2008.
(60) Provisional application No. 61/082,642, filed on Jul. 22, 2008.
(60) Provisional application No. 61/086,242, filed on Aug. 5, 2008.
(60) Provisional application No. 61/084,738, filed on Jul. 30, 2008.
(60) Provisional application No. 61/084,773, filed on Jul. 30, 2008.
(60) Provisional application No. 61/094,394, filed on Sep. 4, 2008.
(60) Provisional application No. 61/094,546, filed on Sep. 5, 2008.
(60) Provisional application No. 61/118,232, filed on Nov. 26, 2008.
(60) Provisional application No. 61/094,584, filed on Sep. 5, 2008.
(60) Provisional application No. 61/094,591, filed on Sep. 5, 2008.
(60) Provisional application No. 61/094,594, filed on Sep. 5, 2008.
(60) Provisional application No. 61/094,611, filed on Sep. 5, 2008.
(60) Provisional application No. 61/095,298, filed on Sep. 8, 2008.
(60) Provisional application No. 61/095,310, filed on Sep. 9, 2008.
(60) Provisional application No. 61/094,183, filed on Sep. 4, 2008.
(60) Provisional application No. 61/094,203, filed on Sep. 4, 2008.
(60) Provisional application No. 61/094,279, filed on Sep. 4, 2008.
(60) Provisional application No. 61/094,294, filed on Sep. 4, 2008.
(60) Provisional application No. 61/094,231, filed on Sep. 4, 2008.
(60) Provisional application No. 61/094,247, filed on Sep. 4, 2008.
(60) Provisional application No. 61/094,310, filed on Sep. 4, 2008.
(60) Provisional application No. 61/103,106, filed on Oct. 6, 2008.
(60) Provisional application No. 61/111,384, filed on Nov. 5, 2008.
(60) Provisional application No. 61/112,131, filed on Nov. 6, 2008.
(60) Provisional application No. 61/121,169, filed on Dec. 9, 2008.

(51) Int. Cl. H04W 40/04

(52) U.S. Cl. 370/252

(57) ABSTRACT

Enhancements are disclosed for wireless ad hoc networking including optimized wireless routing, multicast routing, quick network entry, use of contention domains and node weighting for improved time slot scheduling, and the like. Quality of service may be supported at each node and within scheduling algorithms across a group of nodes in order to provide a number of service levels to network users according to traffic type or the like. These and other enhancements may be used individually or in combination to improve operation of a wireless ad hoc network and support scalability, routing, traffic management, quality of service delivery, and other features.

### RELATED APPLICATIONS

This application is a national stage filing under U.S.C. §371 of published International Application No. PCT/US09/56130 filed on Sep. 4, 2009, which is incorporated herein by reference in its entirety. International Application No. PCT/US09/56130 was published in English as Publication No. WO 2010/028311.

International Application No. PCT/US09/56130 claims priority to the following U.S. Provisional Patent Applications: U.S. App. No. 61/094,546 filed Sep. 5, 2008; U.S. App. No. 61/118,232 filed Nov. 26, 2008; U.S. App. No. 61/094,584 filed Sep. 5, 2008; U.S. App. No. 61/094,591 filed Sep. 5, 2008; U.S. App. No. 61/094,594 filed Sep. 5, 2008; U.S. App. No. 61/094,611 filed Sep. 5, 2008; U.S. App. No. 61/095,298 filed Sep. 8, 2008; U.S. App. No. 61/095,310 filed Sep. 9, 2008; U.S. App. No. 61/103,106 filed Oct. 6, 2008; U.S. App. No. 61/111,384 filed Nov. 5, 2008; U.S. App. No. 61/112,131 filed Nov. 6, 2008; U.S. App. No. 61/121,169 filed Dec. 9, 2008; and U.S. App No. 61/094,394 filed Sep. 4, 2008.

International Application No. PCT/US09/56130 also claims priority to U.S. application Ser. No. 12/418,363 filed on Apr. 3, 2009, which claims the benefit of the following applications: U.S. Provisional App. No. 61/042,431 filed Apr. 4, 2008; U.S. Provisional App. No. 61/042,442 filed Apr. 4, 2008; U.S. Provisional App. No. 61/074,930 filed Jun. 23, 2008; U.S. Provisional App. No. 61/082,618 filed Jul. 22, 2008; U.S. Provisional App. No. 61/082,642 filed Jul. 22, 2008; U.S. Provisional App. No. 61/086,242 filed Aug. 5, 2008; U.S. Provisional App. No. 61/084,738 filed Jul. 30, 2008; U.S. Provisional App. No. 61/084,773 filed Jul. 30, 2008; U.S. Provisional App. No. 61/094,394 filed Sep. 4, 2008; U.S. Provisional App. No. 61/094,546 filed Sep. 5, 2008; U.S. Provisional App. No. 61/118,232 filed Nov. 25, 2008; U.S. Provisional App. No. 61/094,584 filed Sep. 5, 2008; U.S. Provisional App. No. 61/094,591 filed Sep. 5, 2008; U.S. Provisional App. No. 61/094,594 filed Sep. 5, 2008; U.S. Provisional App. No. 61/094,611 filed Sep. 5, 2008; U.S. Provisional App. No. 61/095,298 filed Sep. 8, 2008; U.S. Provisional App. No. 61/095,310 filed Sep. 9, 2008; U.S. Provisional App. No. 61/094,183 filed Sep. 4, 2008; U.S. Provisional App. No. 61/094,203 filed Sep. 4, 2008; U.S. Provisional App. No. 61/094,279 filed Sep. 4, 2008; U.S. Provisional App. No. 61/094,294 filed Sep. 4, 2008; U.S. Provisional App. No. 61/094,231 filed Sep. 4, 2008; U.S. Provisional App. No. 61/094,247 filed Sep. 4, 2008; U.S. Provisional App. No. 61/094,310 filed Sep. 4, 2008; U.S. Provisional App. No. 61/103,106 filed Oct. 6, 2008; U.S. Provisional App. No. 61/111,384 filed Nov. 5, 2008; U.S. Provisional App. No. 61/112,131 filed Nov. 6, 2008; and U.S. Provisional App. No. 61/121,169 filed Dec. 9, 2008.

Each of the foregoing applications is incorporated herein by reference in its entirety.

### FIELD OF INVENTION

This application relates generally to networking and more particularly to wireless ad hoc networking.

### BACKGROUND

Groups of wireless devices may be interconnected in a wireless network. In order to support internetworking among such devices such as Internet connectivity, a central router is typically employed such as a WiFi router for a local area network, or a base station for a cellular or WiMax network. Where the network lacks infrastructure for centralized management, ad hoc techniques may be employed to support various network functions and provide backhaul to a global public network such as the Internet. However, there remains a need for improved wireless ad hoc network systems and methods to support more robust, self-forming networks capable of Internet routing, Quality of Service delivery, and other advanced network features.

### SUMMARY

Enhancements are disclosed for wireless ad hoc networking including optimized wireless routing, multicast routing, quick network entry, use of contention domains and node weighting for improved time slot scheduling, and the like. Quality of service may be supported at each node and within scheduling algorithms across a group of nodes in order to provide a number of service levels to network users according to traffic type or the like. These and other enhancements may be used individually or in combination to improve operation of a wireless ad hoc network and support scalability, routing, traffic management, quality of service delivery, and other features.

Various methods, techniques, apparatus and the like are described to facilitate wireless ad hoc network communications. In embodiments, a method for wireless communication within a wireless ad hoc network, may comprise: identifying criteria and weightings for a multivariate route cost calculation for each of a plurality of traffic types; identifying possible routes to each destination within a backhaul access point routing domain; applying the multivariate route cost calculation to determine a lowest-cost route to each destination within the backhaul access point routing domain for each one of the plurality of traffic types thereby providing routing data; storing the routing data in a routing matrix accessible by traffic type and destination; identifying a transmit traffic type and a transmit destination for data in a transmit queue; looking up the lowest-cost route to the transmit destination for the transmit traffic type in the routing matrix; and transmitting the data to the transmit destination according to the lowest-cost route. In embodiments, the method may further comprise updating the routing matrix using a scoped link state routing algorithm. The plurality of traffic types may include Voice over Internet Protocol, and wherein the weightings for the multivariate route cost calculation are selected to minimize a number of hops to each transmit destination. The plurality of traffic types may include one or more Quality of Service levels. The plurality of traffic types includes one or more prioritization levels. The plurality of traffic types may include one or more of host traffic, voice data, audio download data, streaming video, and binary information. The criteria may include one or more of a power level, a link quality, a node bandwidth, and a number of hops. The criteria may include one or more items selected from a group of power usage by a node, mobility of a node, CPU processing requirements, configuration requirements, congestion at certain nodes, and adaptive data rate (ADR) information. The weighting for one or more of the criteria may be chosen by a user. The transmit destination may include a backhaul access point for any destination outside the backhaul access point routing domain.

In some embodiments, a node in a wireless ad hoc network may comprise: a data source; a radio for operating within the wireless ad hoc network; a memory for storing routing information; and a processor programmed to identify criteria and weightings for a multivariate route cost calculation for each of a plurality of traffic types; identify possible routes to each destination within a backhaul access point routing domain; apply the multivariate route cost calculation to determine a lowest-cost route to each destination within the backhaul access point routing domain for each one of the plurality of traffic types thereby providing routing data; store the routing data in a routing matrix accessible by traffic type and destination; identify a transmit traffic type and a transmit destination for data in a transmit queue; look up the lowest-cost route to the transmit destination for the transmit traffic type in the routing matrix; and transmit the data to the transmit destination according to the lowest-cost route. In embodiments, the processor may be further programmed to update the routing matrix using a scoped link state routing algorithm.

In some embodiments, a method for wireless multicast communication may comprise: joining a multicast group within a wireless ad hoc network as a receiving node for multicast traffic; flooding the multicast group with a Join Request Packet (JRP) from the receiving node; receiving a Join Table Packet (JTP) from a sending node within the multicast group that receives the JRP, the JTP returned to the receiving node along a path travelled by the JRP to the sending node and the JTP identifying one or more mode queues having different data rates for each node along the path; constructing a multicast tree for forwarding multicast traffic within the multicast group based upon the JTP; and receiving a multicast message according to the multicast tree, the multicast message received by the receiving node using a highest mode available queue of the one or more mode queues for each node within the multicast group. The method may further comprise receiving a plurality of JTPs from a plurality of sending nodes and constructing a multicast tree based upon the plurality of JTPs. The highest mode available queue may be a most common highest mode available queue within the multicast group. The multicast message may be prioritized according to a quality of service. The quality of service may include a highest quality of service for prioritizing data across all of the one or more mode queues. The quality of service may include a highest quality of service for which all such data is transmitted from all of the one or more mode queues before a next quality of service data is transmitted from any of the one or more mode queues. The method may further comprise joining the multicast group from a second receiving node and flooding the multicast group with a JRP from the second receiving node. The method may further comprise updating the multicast group. Updating the multicast group may include exchanging information within the multicast group about link quality. The multicast traffic to be transmitted may be copied from the highest mode available queue to a lower mode queue in at least one intermediate node between the sending node and the receiving node.

In some embodiments, a node in a wireless ad hoc network may comprise: a radio for operating within the wireless ad hoc network; a memory; and a processor programmed to operate the radio to join a multicast group within the wireless ad hoc network as a receiving node for multicast traffic; to flood the multicast group with a Join Request Packet (JRP) from the receiving node; to receive a Join Table Packet (JTP) from a sending node within the multicast group that receives the JRP, the JTP returned to the receiving node along a path travelled by the JRP to the sending node and the JTP identifying one or more mode queues having different data rates for each node along the path; to construct a multicast tree for forwarding multicast traffic within the multicast group based upon the JTP and store the multicast tree in the memory; and to receive a multicast message according to the multicast tree, the multicast message received by the receiving node using a highest mode available queue of the one or more mode queues for each node within the multicast group. The processor may be further programmed to receive a plurality of JTPs from a plurality of sending nodes and to construct a multicast tree based upon the plurality of JTPs. The processor may be further programmed to update the multicast group. The processor may be further programmed to update the multicast group based upon an exchange of information within the multicast group about link quality.

In some embodiments, a method for wireless communication and routing within a wireless ad hoc network may comprise: discovering one or more neighbor nodes to a node in the wireless ad hoc network; obtaining information on the one or more neighbor nodes and storing the information in a neighbor table for the node; determining which of the one or more neighbor nodes has a lowest-cost route to a backhaul access point; selecting the lowest-cost route from the one or more neighbor nodes as a default route from the node to the backhaul access point; and transmitting data to one of the one or more neighbor nodes for communication to the backhaul access point according to the default route. The method may further comprise performing a route cost analysis to determine a lowest-cost route from the node to the backhaul access point and replacing the default route with the lowest-cost route from the node to the backhaul access point. The method may further comprise sending a unicast route request from the node on the default route. The method may further comprise building a reverse route table along the default route at one of the one or more neighbor nodes which is a part of the default route. The method may further comprise issuing a route update from the backhaul access point. The method may further comprise sending a route request acknowledgement from the backhaul access point to the node. The default route may be modified to a different route than the lowest-cost route from the one or more neighbor nodes. The default route may be modified because a route request acknowledgement is not received from the backhaul access point and the different route is a next lowest-cost route from the one or more neighbor nodes. The discovering may occur when the node is powered up. The discovering may occur when the node is mobile and moves locations where the node has one or more new neighbor nodes.

In some embodiments, a node in a wireless ad hoc network may comprise: a radio for operating within the wireless ad hoc network; a memory; and a processor programmed to discover one or more neighbor nodes to the node in the wireless ad hoc network with the radio; to obtain information on the one or more neighbor nodes with the radio and store the information in the memory as a neighbor table for the node; to determine which of the one or more neighbor nodes has a lowest-cost route to a backhaul access point; to select the lowest-cost route from the node to the backhaul access point as a default route; and to transmit data with the radio to one of the one or more neighbor nodes for communication to the backhaul access point according to the default route. The processor may be further programmed to determine a lowest-cost route from the node to the backhaul access point and replace the default route with the lowest-cost route from the node to the backhaul access point. The processor may be further programmed to send a unicast route request from the node on the default route. The processor may be further programmed to build a reverse route table along the default route at one of the one or more neighbor nodes which is a part of the default route. The processor may be further programmed to issue a route update from the backhaul access point. The processor may be further programmed to send a route request acknowledgement from the backhaul access point to the node.

In some embodiments, a method for wireless communication may comprise: synchronizing timing between a node and one or more neighbor nodes in a neighborhood of a wireless ad hoc network; determining a link quality between the node and at least one of the one or more neighbor nodes; storing the link quality in a neighbor table for the node; identifying time slots for communication by the node wherein the time slots include control slots and data slots, the control slots further including network entry slots that are randomly accessible on a contention basis and scheduled control slots for which access is scheduled on a predetermined basis within the neighborhood; sending network entry information to the one or more neighbor nodes using one of the network entry slots, the network entry information including a node identity for the node and the link quality; and transmitting neighbor information using one of the scheduled control slots allocated to the node, the neighbor information including data for updating a neighbor table at one or more of the neighbor nodes. Synchronizing timing may include obtaining timing from outside the wireless ad hoc network. Synchronizing timing may include obtaining timing from one or more global positioning system (GPS) satellites. Synchronizing timing may include exchanging timing information between the node and the one or more neighbor nodes to synchronize timing oscillators. In some embodiments, the method may further comprise detecting a collision when sending network entry information. The method may further comprise counting down a random backoff counter before retransmitting the network entry information in one of the network entry slots. The method may comprise setting the random backoff counter based on a number of nodes within the neighborhood. The method may further comprise dynamically converting one of the data slots into one of the scheduled control slots. The method may further comprise dynamically converting one of the data slots into one of the scheduled control slots when a threshold is exceeded for a number of time slots which have passed since the node has transmitted on one of the scheduled control slots. The method may further comprise dynamically converting one of the scheduled control slots into one of the data slots.

In embodiments, a node in a wireless ad hoc network may comprise: a radio for operating within the wireless ad hoc network; a memory; and a processor programmed to synchronize timing between a node and one or more neighbor nodes in a neighborhood of the wireless ad hoc network; to determine a link quality between the node and at least one of the one or more neighbor nodes; to store the link quality in a neighbor table in the memory of the node; to identify time slots for communication by the node wherein the time slots include control slots and data slots, the control slots further including network entry slots that are randomly accessible on a contention basis and scheduled control slots for which access is scheduled on a predetermined basis within the neighborhood; to send network entry information with the radio to the one or more neighbor nodes using one of the network entry slots, the network entry information including a node identity for the node and the link quality; and to transmitting neighbor information with the radio using one of the scheduled control slots allocated to the node, the neighbor information including data for updating a neighbor table at one or more of the neighbor nodes. The processor may be further programmed to synchronize timing by obtaining timing from outside the wireless ad hoc network. The processor may be further programmed to synchronizing timing by obtaining timing from one or more global positioning system (GPS) satellites. The processor may be further programmed to synchronize timing by exchanging timing information between the node and the one or more neighbor nodes to synchronize timing oscillators. The processor may be further programmed to detect a collision when sending network entry information. The processor may be further programmed to count down a random backoff counter before retransmitting the network entry information in one of the network entry slots. The processor may be further programmed to set the random backoff counter based on a number of nodes within the neighborhood. The processor may be further programmed to dynamically convert one of the data slots into one of the scheduled control slots. The processor may be further programmed to dynamically convert one of the data slots into one of the scheduled control slots when a threshold is exceeded for a number of time slots which have passed since the node has transmitted on one of the scheduled control slots. The processor may be further programmed to dynamically convert one of the scheduled control slots into one of the data slots.

In embodiments, a method for operating a node in a wireless network may comprise: identifying a plurality of nodes in a neighborhood including the node and one or more neighbor nodes; calculating a node score indicative of traffic congestion for the node and a node weight indicative of access requirements for the node; receiving a neighbor node score indicative of traffic congestion from each of the one or more neighbor nodes and a neighbor node weight indicative of access requirements from each of the one or more neighbor nodes; identifying a time slot for communication within the neighborhood; restricting access to the time slot by the node when the node weight for the node does not meet a node weight requirement; applying a scheduling algorithm based on the node score and the node weight to determine whether the node can access the time slot when the node has a node weight that meets the node weight requirement; and transmitting data from the node in the time slot when the node is scheduled for access to the time slot. The node weight requirement may include a minimum threshold for the node weight or a maximum threshold for the node weight. The node weight requirement may include an inclusive threshold for the node weight or an exclusive threshold for the node weight. The scheduling algorithm may be based on the neighbor node weight for one or more of the neighbor nodes and the neighbor node score for one or more of the neighbor nodes. The scheduling algorithm may be based upon neighbor data exchanged among the plurality of nodes in the neighborhood and stored in a neighbor table of the node. In some embodiments, the method may further comprise restricting access to the time slot by each one of the neighbor nodes that has a neighbor node weight that does not meet the node weight requirement. Restricting access may include withholding the node from participation in the scheduling algorithm for access to the time slot. The neighborhood may include a two hop neighborhood for the node. In some embodiments, the method may further comprise generating a random number for each one of the plurality of nodes in the neighborhood having a specific node weight and further restricting access to the time slot based on the random number. The node weight may be calculated based on one or more of a power level, a geographic location, a mobility, a node type, and a frequency of operation.

In some embodiments, a node in a wireless ad hoc network may comprise: a data source; a radio for operating within the wireless ad hoc network; a memory; and a processor programmed to identify a plurality of nodes in a neighborhood including the node and one or more neighbor nodes; to calculate a node score indicative of traffic congestion for the node and a node weight indicative of access requirements for the node; to receiving and store in the memory a neighbor node score indicative of traffic congestion from each of the one or more neighbor nodes and a neighbor node weight indicative of access requirements from each of the one or more neighbor nodes; to identify a time slot for communication within the neighborhood; to restrict access to the time slot by the node when the node weight for the node does not meet a node weight requirement; to apply a scheduling algorithm based on the node score and the node weight to determine whether the node can access the time slot when the node has a node weight that meets the node weight requirement; and to transmitting data from the data source with the radio in the time slot when the time slot is scheduled for the node. The processor may be further programmed to restrict access to the time slot by each one of the neighbor nodes that has a neighbor node weight that does not meet the node weight requirement. The processor may be further programmed to restrict access by withholding the node from participation in the scheduling algorithm for access to the time slot. The processor may be further programmed to generate a random number for each one of the plurality of nodes in the neighborhood having a specific node weight and further restricting access to the time slot based on the random number.

In embodiments, a method for operating a node in a wireless ad hoc network may comprise: identifying a plurality of nodes in a neighborhood including the node and one or more neighbor nodes; calculating a node score indicative of traffic congestion for the node and a node weight indicative of access requirements for the node; receiving a neighbor node score indicative of traffic congestion from each of the one or more neighbor nodes and a neighbor node weight indicative of access requirements from each of the one or more neighbor nodes; determining a quality of service (QoS) requirement for data to be transmitted from the node; skewing the node weight for the node and the neighbor node weight for each neighbor node based on the QoS requirement to provide a QoS node weight for each node in the neighborhood; identifying a time slot for communication within the neighborhood; restricting access to the time slot by the node when the QoS node weight for the node does not meet a node weight requirement; applying a scheduling algorithm based on the node score and the QoS node weight for the node to determine whether the node can access the time slot when the node meets the node weight requirement; and transmitting data from the node in the time slot when the node is scheduled for access to the time slot. Skewing may include using a hash function. Skewing may include prioritizing the data based on the QoS requirement. Skewing may include skewing according to the QoS requirement for traffic at each node in the neighborhood. The QoS requirement for data to be transmitted from the node may include one of a plurality of QoS levels for the data. Determining the QoS requirement for data may include inspecting a header of the data for QoS information. Determining the QoS requirement for data may include determining a traffic type of the data. The scheduling algorithm may be based upon neighbor data exchanged among the plurality of nodes in the neighborhood and stored in a neighbor table of the node. Restricting access may include withholding the node from participation in the scheduling algorithm for access to the time slot. The neighborhood may include a two hop neighborhood for the node.

In embodiments, a node in a wireless ad hoc network may comprise: a data source; a radio for operating within the wireless ad hoc network; a memory; and a processor programmed to perform the steps of: identifying a plurality of nodes in a neighborhood including the node and one or more neighbor nodes; calculating a node score indicative of traffic congestion for the node and a node weight indicative of access requirements for the node; receiving with the radio a neighbor node score indicative of traffic congestion from each of the one or more neighbor nodes and a neighbor node weight indicative of access requirements from each of the one or more neighbor nodes; determining a quality of service (QoS) requirement for data to be transmitted from the data source; skewing the node weight for the node and the neighbor node weight for each neighbor node based on the QoS requirement to provide a QoS node weight for each node in the neighborhood stored in the memory; identifying a time slot for communication within the neighborhood; restricting access to the time slot by the node when the QoS node weight for the node does not meet a node weight requirement; applying a scheduling algorithm based on the node score and the QoS node weight for the node to determine whether the node can access the time slot when the node meets the node weight requirement; and transmitting data from the node with the radio in the time slot when the node is scheduled for access to the time slot.

In embodiments, a method for wireless communication within a wireless ad hoc network may comprise: discovering one or more neighbor nodes to a node in the wireless ad hoc network wherein the one or more neighbor nodes are within a one-hop neighborhood; creating a neighbor table for the one or more neighbor nodes; collecting data from the one or more neighbor nodes wherein the data comprises inter-node link loss and Euclidean link distance; identifying a common set of nodes from the node and the one or more neighbor nodes where each of the common set of nodes are one-hop neighbors of each other node in the common set of nodes; reducing the data which was collected in the neighbor table so that a reduced neighbor table includes only information on the common set of nodes; selecting neighbors to limit a number of links between the common set of nodes; constructing routing trees with access point s at a root of each routing tree and including one or more nodes from the common set of nodes on routes through the neighbors which were selected; determining a lowest-cost route from each of the common set of nodes through the routing trees; assigning frequency and time slots to maximize traffic supportable on the routing trees; and communicating signals through the routing trees on the frequency and time slots which were assigned. The selecting neighbors to limit the number of links may further comprise assembling a Delaunay tessellation based on one of a group comprising the link loss and the Euclidean link distance. The selecting neighbors to limit the number of links further comprises performing cost route analysis from each of the common set of nodes and performing graph analysis of resulting routes from the route analysis. The route analysis is based on a minimum transmit energy.

Various features, aspects, and advantages of various embodiments will become more apparent from the following further description.

### BRIEF DESCRIPTION OF THE DRAWINGS

The invention and the following detailed description of certain embodiments thereof may be understood by reference to the following figures wherein:

FIG. 1 is a block diagram of a Mobile Ad Hoc Network (MANET).

FIG. 2 shows a MANET Wireless Protocol that may be used by devices within a MANET.

FIG. 3 is a block diagram of a node in a wireless ad hoc network.

FIG. 4 shows a MANET containing two MANET BAP domains.

FIG. 5 illustrates information maintained by nodes in a MANET protocol.

FIG. 6 shows alternative least cost paths to a BAP within a BAP domain.

FIG. 7 is a flowchart of a method for implementing cost based routing.

FIG. 8 is a flowchart of a method for determining route costs.

FIG. 9 shows a number of nodes in a MANET along with their respective modes.

FIG. 10 shows multiple mode queues supporting different levels of QoS.

FIG. 11 is a flowchart of a method for performing multicast routing.

FIG. 12 is a flowchart of a method for providing fast entry to a backhaul domain.

FIG. 13 shows a TDMA time slot structure.

FIG. 14 shows a MANET with one-hop and two-hop neighborhoods.

FIG. 15 is a flowchart of a method for entering a network with a non-GPS node.

FIG. 16 is a flowchart of a method for entering a network with a GPS-enabled node.

FIG. 17 is a flowchart of a method for updating information for a node that is already in a network.

FIG. 18 is a flowchart of a method for a node leaving a network.

FIG. 19 is a flowchart of a method for updating link quality.

FIG. 20 shows a MANET with node scores.

FIG. 21 shows a MANET with node weights.

FIG. 22 shows a MANET with modified node scores.

FIG. 23 shows a MANET considering a subset of node weights.

FIG. 24 shows TDMA for node weighting.

FIG. 25 is a flowchart of a method for weighted transmission.

FIG. 26 is a flowchart of a method for transmission based on weights.

FIG. 27 is a flowchart of a method for transmission based on QoS.

FIG. 28 shows a process for increasing capacity in a MANET.

### DETAILED DESCRIPTION

The present disclosure provides a description of various apparatus and techniques which facilitate wireless ad hoc network communications.

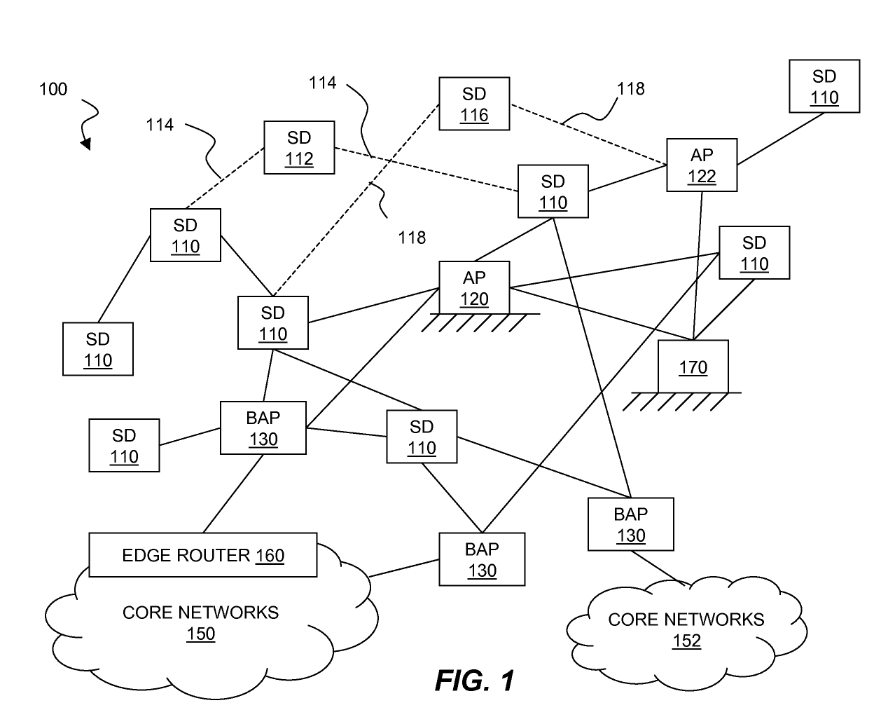

FIG. 1 shows a Mobile Ad Hoc Network (MANET) that may be used with the systems and methods described herein. In general, a MANET 100 (also referred to generally herein as a network 100) may include subscriber devices 110, access points 120, and backhaul access points 130 (for coupling to a core network 150 such as the Internet), all generally interconnected to one another as shown for example in FIG. 1. Without limiting the generality of the foregoing, one or more of the subscriber devices 110 may be a stationary device 170 that does not geographically move within the MANET 100. It will be understood that the device-to-device links illustrated in FIG. 1 are for purposes of illustration only, and in no way are intended to limit the nature or number of links between devices in the MANET 100, which may be created, removed, and/or modified over time according to any corresponding protocols followed by the devices within the MANET 100. In general, the links among devices or components within the MANET 100 are wireless links, although wired links may optionally be employed in various locations such as between the backhaul access point 130 and the core networks 150. In order to maintain the MANET 100, typically one or more protocols are shared among the participating devices to control creation, removal, and modification of individual data links between devices, and to route traffic and control information among the devices. The term protocol as used herein generally refers to any and all such rules, procedures, and/or algorithms used in maintaining the MANET 100, unless a specific protocol is explicitly stated or otherwise clear from the context.

Subscriber devices 110 may include any general purpose nodes participating in the MANET 100 according to suitable protocols. Subscriber devices 110 may, for example, include terminal nodes that send or receive data. Subscriber devices 110 may also or instead suitably be employed as intermediate nodes to route traffic to and from other subscriber devices 110. Thus an ad hoc network as described herein is generally extensible, and as new subscriber devices 110 appear within the MANET 100, they may form a part of the MANET 100 fabric that routes traffic among other nodes. A new subscriber device 112 may be introduced to the MANET 100 with new links 114 being added as the new subscriber device 112 is detected. Devices may also periodically leave the MANET 100 such as a departing subscriber device 116. As the departing subscriber device 116 leaves the network, links 118 between the departing subscriber device 116 and other subscriber devices 110, access points 122, stationary devices 170, backhaul access points 130, and/or other devices may be severed. This may occur, for example when a device moves beyond geographical boundaries of the MANET 100, when devices in the MANET are turned off (or their wireless or networking capabilities are suspended), or when a hardware or software malfunction occurs. The MANET 100 may in a centralized or distributed manner detect new and/or departing devices and/or links in order to maintain substantially continuous connectivity for devices in the MANET 100.

In general, a subscriber device 110 may include any network or computing device that includes a wireless interface, network protocol stack(s), and the like adapted to participate in the MANET 100. The Internet Protocol may usefully be employed in subscriber devices 110 within the MANET 100 in order to use well-established addressing schemes and the like. A subscriber device 110 may include without limitation a cellular phone, personal digital assistant, wireless electronic mail client, laptop computer, palmtop computer, desktop computer, video device, digital camera, electrical instrument, sensor, detector, display, media player, navigation device, smart phone, wireless networking card, wireless router (e.g., for a local WiFi network), storage device, printer, or any other device that might usefully participate in a network. In some embodiments subscriber devices may include a GPS receiver providing a position and timing reference. In embodiments, each subscriber device 110 may be authenticated and/or authorized before being granted access to the MANET 100.

Access points 120 may be provided to establish a permanent or otherwise generally stable infrastructure to the MANET 100. An access point 120 may be fixed in location or may be limited in the amount that it can move. One or more of the access points 120 may be mobile access points 122 that can freely move within the MANET 100. The access points 120 may employ identical network functionality and protocol stacks as the subscriber devices 110 described above. The access points 120 may also or instead encapsulate different functionality consistent with a more specialized role in the MANET 100. In one aspect, the access points 120 may have no associated computing device that originates or consumes network traffic. That is, the access points 120 may simply form a mesh of participants in the MANET 100 and relay traffic among other network participants. An access point 120 may also include a physical connection to a power infrastructure so that it may be physically installed at a location and operate autonomously without requiring regular maintenance for battery changes and the like. In another aspect, access points 120 may include some minimal supplemental circuitry related to, e.g., status and diagnostics, or for receiving software updates and the like. By arranging a spanning network of access points 120 network continuity may be improved in areas where subscriber devices 110 are not present or are not expected to be present with any regularity. In embodiments an access point 120 may be of a size and weight making it suitable for mounting and/or concealment in a variety of locations including indoor and outdoor locations, and including mounting on walls, floors, ground, ceilings, roofs, utility poles, and so forth.

Each access point 120 may include or utilize a timing reference such as any of the Network Timing Protocols described in RFC 778, RFC 891, RFC 956, RFC 958, RFC 1305, RFC 1361, RFC 1769, RFC 2030, and RFC 4330, all published by The Internet Engineering Task Force. Each access point may also, or instead, include a GPS receiver providing a position and timing reference, or any other open or proprietary timing system may be employed.

In embodiments the access points 120 may have a greater transmit power and/or a greater antenna gain than mobile subscriber devices 110, thus providing greater physical coverage than some other devices within the MANET 100.

The MANET 100 may include one or more backhaul access points 130 that generally operate to connect nodes within the MANET 100 to a core network 150 such as the Internet. A core network 150 may be a fixed network or may be an infrastructure network. On one interface, a backhaul access point 130 may have a wireless radio interface, protocol stack(s) and other components of other nodes within the MANET 100. On another interface, the backhaul access point 130 may provide any suitable interface to the core network 150. The backhaul access point 130 may, for example, be deployed at a fiber access point or the like that provides high-speed data capacity for Internet traffic or the like. For example and without limitation, the fiber access point may include a Gig-E router site or an OC-3/12 add-drop multiplexer site. In an embodiment the backhaul access point 130 may include two Gig-E interfaces for backhaul connections. It will be understood that any number and variety of suitable interfaces for backhaul connections may be usefully employed with a backhaul access point 130 as described herein.

A backhaul access point 130 may serve multiple access points 120 within the MANET 100, and may distribute network load across those access points. Alternatively, a single backhaul access point 130 may serve a single access point 120. The number of access points 120 served by a backhaul access point 130 may depend on various factors such as the amount of intra-MANET traffic and extra-MANET traffic, the nature and direction of multicast versus unicast data, and so forth. This association between backhaul access points 130 and access points 120 may change from time to time depending on the presence of other subscriber devices 110 within the area, network conditions, network traffic demands, and so forth. In some cases or under some operating conditions, an access point 120 may be associated with more than one backhaul access point 130.

An edge router 160 may be included between the core network 150 and one or more backhaul access points 130. The edge router 160 may facilitate routing between the MANET 100 and the core networks 150. The core networks 150 may be connected through an edge router 160 to a backhaul access point 130 or may be directly connected to a backhaul access point 130 without going through the edge router 160. More than one edge router 160 may be used to contact multiple backhaul access points 130. In embodiments one edge router may contact multiple backhaul access points 130. The edge router 160 may include any devices or systems for maintaining connectivity between the MANET 100 and the core networks 150, and may further support or enhance network activity within the MANET 100. For example, the edge router 160 may include an industry standard and/or proprietary Address Resolution Protocol server, an application server, a Virtual Private Network server, a Network Address Translation server, a firewall, a Domain Name System server, a Dynamic Host Configuration Protocol server, and/or an Operations, Administration, Maintenance and Provisioning server, and the like, as well as any combination of the foregoing. These various components may be integrated into the edge router 160, or may be provided as separate (physical and/or logical) systems that support operation of the edge router 160. These supporting systems may in general support operations such as broadband Internet connectivity within the MANET 100, broadcast communications crossing between the MANET 100 and the core networks 150, and so forth, as well as the use of multiple backhaul access points 130 to efficiently route inter-MANET (and/or intra-MANET) traffic among subscriber devices 110.

The core networks 150 may include any network resources outside the MANET 100. As shown in FIG. 1, there may be any number of different core networks, which may for example include a second core network 152 connected to the MANET 100 through a backhaul access point 130. The second core network 152 may be wholly independent from the core network 150, or may connect to the core network 150 through a fixed or other type of network. The core networks 150 may connect disparate, geographically remote and/or local instances of the MANET 100 to form a single network. The core networks 150 may include any and all forms of IP networks, including LANs, MANs, WANs, and so on. The core networks 150 may also or instead include the public Internet, the Public Switched Telephone Network, a cellular communications network, or any other network or combination of networks for data traffic, voice traffic, media broadcasting, and so forth. In other embodiments the core networks 150 may consist exclusively of a single zone of administrative control, or a number of zones of administrative control, or some combination of an administrative zone and any of the foregoing.

The stationary device 170 may include any subscriber device 110 that, for whatever reason, does not physically move within the MANET 100. In general, such fixed physical points within the MANET 100 may provide useful routing alternatives for traffic that can be exploited for load balancing, redundancy, and so forth. This may include, for example, a fixed desktop computer within the MANET 100.

Communication within the MANET 100 may be accomplished via protocols, referred to collectively herein as the MANET Wireless Protocol (MWP). In general, any of the nodes above that participate in the MANET 100 according to the MWP may include a hardware platform enabling radio software and firmware upgrades, which may include for example a dedicated or general purpose computing device, memory, digital signal processors, radio-frequency components, an antenna, and any other suitable hardware and/or software suitable for implementing the MWP in participating nodes.

In embodiments, any of the foregoing devices such as one of the access points 120 may also include an adapter for other networks such as an Ethernet network adapter or equivalent IP network adapter, router, and the like, so that non-MANET equipment can participate in the MANET 100 through the device. It will also be appreciated that, while connections to core networks 150, 152 are shown, this connection is optional. A MANET 100 (with or without access points 120) may be maintained independently without connections to any other networks, and may be usefully employed for the sole purpose of trafficking data among subscriber devices 110.

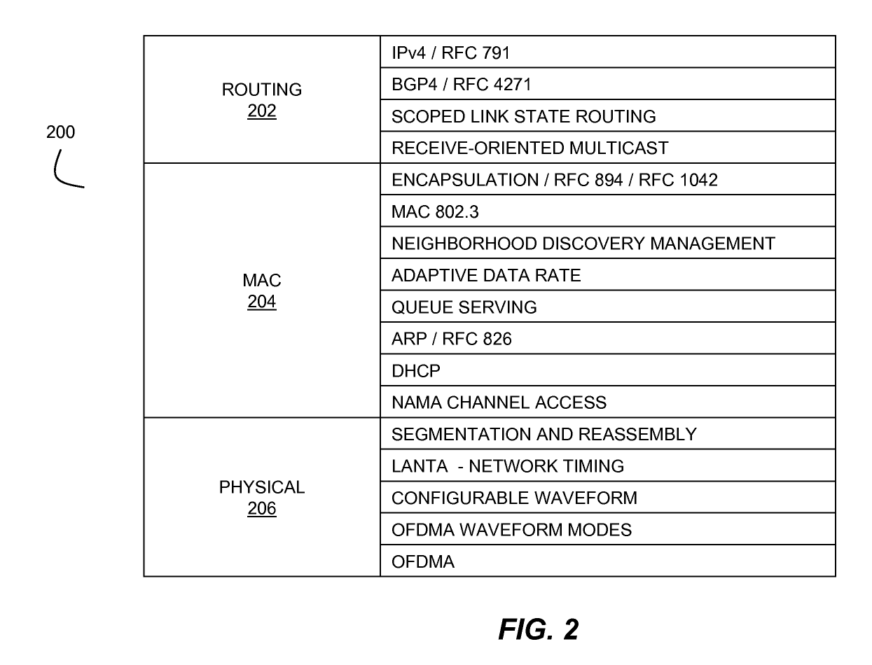

FIG. 2 shows a MANET Wireless Protocol (MWP) stack that may be used by devices within the MANET 100 of FIG. 1.

In general, a protocol stack provides a reference model for communications among network devices so that functions necessary or useful for network communications are available while each functional layer can be designed, modified, and/or deployed free from the implementation details of neighboring layers. Methods and systems disclosed herein may employ any suitable protocol stack to support wireless communications among devices. This may include, for example the Open Systems Interconnection (OSI) Reference Model (with seven layers labelled Application, Presentation, Session, Transport, Network, Data Link (LLC & MAC), and Physical) or the TCP/IP model (with four layers labelled Application, Transport, Internet, Link) along with any adaptations or variations thereof suitable for use in a MANET, or any entirely different computer network protocol design. The lower layer(s) of a protocol stack that support physical interfaces, medium access control, routing and the like may be modified to accommodate mobile wireless ad hoc networking while industry-standard protocols are supported at the routing layer (e.g., for routing at a MANET boundary and/or beyond) and above. In this manner, industry standard applications and devices may be employed within the MANET while using the MANET infrastructure to manage communication. Thus, applications designed for the fixed Internet may be deployed in the MANET, and vice versa, without requiring intervention, such as of a carrier or service provider.

In various embodiments, functions within each layer may be augmented, reduced, or modified on a device-by-device basis. For example, the functionality of each of the layers may be pruned to meet specific requirements without deviating from the scope of the invention. The function(s) of a particular layer may be implemented in software and/or hardware without deviating from the scope of the invention.

As shown in FIG. 2, the layers of a MANET Wireless Protocol (MWP) stack may include a routing layer 202, a medium access control (“MAC”) layer 204, and a physical layer 206. By way of example and not of limitation, each of these layers and the associated functions are now discussed in greater detail.

The routing layer 202 may implement industry standards for routing such as IPv4/RFC 791 and BGP4/RFC 4271. The routing layer 202 may also implement wireless ad hoc networking technologies to replace, e.g., OSPF/RFC 2740 such as scoped link state routing and/or receiver-oriented multicast. This layer may for example support industry-standard unicast and multicast routing protocols at a boundary between a MANET and a fixed network while providing propriety unicast and multicast routing within the MANET.

The MAC layer 204 may implement industry standards for medium access control such as RFC's 894/1042 for encapsulation, MAC 802.3, ARP/RFC 826, and DHCP. The MAC layer 204 may also implement wireless ad hoc networking technologies to replace, e.g., 802.2 LLC and 802.1q such as neighbor discovery management, adaptive data rates, and proprietary queue serving. Similarly, PPP/RFC's 1661/2516 may be substituted with proprietary link scheduling and/or node activated multiple access (NAMA) channel access. The MAC layer 204 may, for example, support quality of service differentiation using channel access and/or queue servicing to prioritize delay-sensitive traffic. In this layer, neighbor management may establish network entry for devices and track changes in each node's local one-hop and two-hop neighborhoods, such as through a message exchange with one-hop neighbors. The MAC layer 204 may support adaptive power control by adjusting transmit power on a link-by-link basis in a MANET in a manner that, e.g., maximizes transmission capacity while minimizing interference according to link conditions and topology. Adaptive data rates may be employed on a link-by-link basis to maximize transmission capacity according to individual link conditions. Queue servicing may provide buffers for data awaiting transmission through a physical layer 206 interface, and may incorporate differentiated quality of service. At the same time, channel access may be used to determine which node transmits in each TDMA time slot, with a schedule influenced by quality-of-service parameters.

The physical layer 206 may implement wireless technologies such as segmentation and reassembly of physical layer transmissions, local area node tracking algorithm (LANTA) network timing, and slot-by-slot configurable waveforms, as well as multiple waveform modes including time domain multiple access and frequency domain multiple access waveforms, or more generally any waveforms that support multiplexing or multiple access based on time, frequency, coding, or the like. In general network timing is also provided within the physical layer 206, and may correct time and frequency errors to ensure that all nodes are operating with a common time base. At the same time, waveform mode self-discovery may be employed so that each receiver can autonomously discover which waveform mode was sent from a transmitter.

These and other functions and details of operation of a MANET Wireless Protocol stack are described in greater detail for example in U.S. application Ser. No. 12/418,363 filed on Apr. 3, 2009, the entire contents of which are incorporated herein by reference.

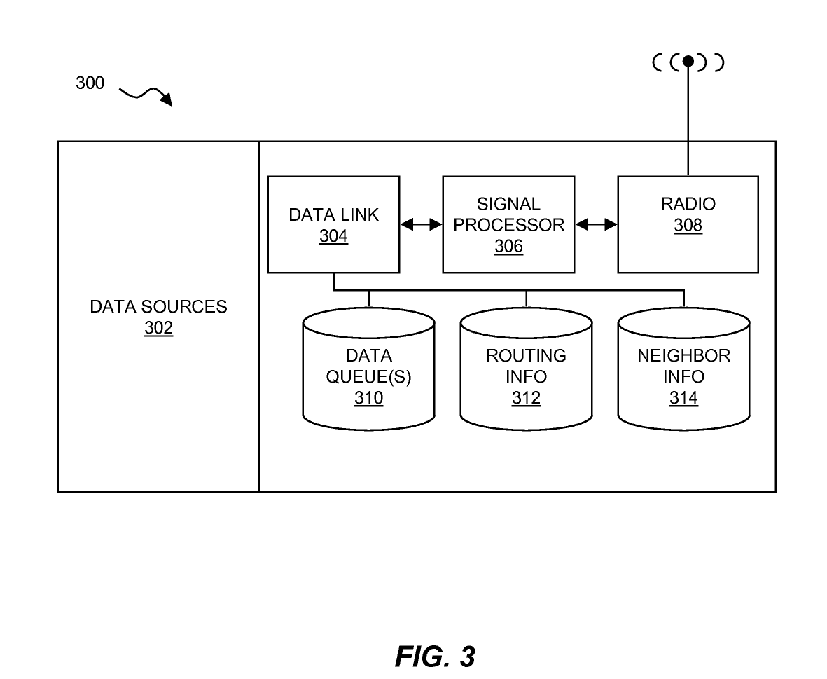

FIG. 3 is a block diagram of a node in a wireless ad hoc network such as the MANET described above. The node may be any of the devices described above, such as a subscriber device, access point, or backhaul access point. In general the node 300 may include data sources 302, a data link 304, a signal processor 306, a radio 308, data queues 310, routing information 312, and neighborhood information 314. It will be understood that the following description is general in nature, and that numerous arrangements of processing, storage, and radio frequency hardware may be suitably employed to similar affect. This description is intended to outline certain operations of a MANET node relevant to the systems and methods described herein, and in no way limits the invention to the specific architecture shown in FIG. 3.

The data sources 302 may include any applications or other hardware and/or software associated with the node 300. This may include, for example, programs running on a laptop or other portable computing device, a web server or client, a multimedia input and/or output sources such as a digital camera or video, and so forth. More generally any device, sensor, detector, or the like that might send or receive data may operate as a data source 302 in the node 300. It will be further understood that some nodes such as access points 104 may not have independent data sources 302, and may function exclusively as MANET 100 network elements that relay data among other nodes and/or provide network stability as generally described above.

The data link 304 may include hardware and/or software implementing data link layer functionality such as neighbor management, segmentation and reassembly of data packets, Quality of Service (QoS) management, data queue servicing, channel access, adaptive data rates, and any other suitable data link functions. In general, the data link 304 controls participation of the data sources 302, and more generally the node 300, in a MANET. It will be understood that the data link 304 in FIG. 3 may implement any number of lower layer (e.g., physical layer) or higher layer (e.g., routing, transport, session, presentation, application) protocols from a conventional Open Systems Interconnection (OSI) Model, or any such protocols and related functions may be implemented elsewhere within the node 300, such as in an IP stack executing on the data source 302, or in firmware within the signal processor 306 or radio 308, or in additional functional blocks not depicted in FIG. 3. For example, routing protocols may be implemented within hardware/software of the data link 304 in order to ensure that nodes in the MANET 100 share appropriate routing functions. Thus it will be appreciated that while the certain elements discussed herein might suitably be placed within the data link layer of a formal protocol stack, the systems and methods of this disclosure might also or instead be implemented with variations to a conventional protocol stack, or without any formal protocol stack whatsoever.

The data link 304 may include a link manager that collects neighbor information from the data link layer, and may form and maintain the neighborhood information 314 for the node 300. This table may be used to establish routes to neighbors, and may be updated periodically with information from one and two hop neighbors as described further below. The link manager may monitor statistics on all active links for a node on a link-by-link basis in order to support link quality calculations and other functions described herein. The term metadata is used herein to generally refer to the neighborhood information 314 for the node 300 or any other information characterized one or more nodes, data links, or other network characteristics that might be shared among nodes to describe the network in which nodes are participating and communicating. In general, the metadata includes at least one item of metadata, although any number of metadata items might be usefully employed according to the number of nodes in a neighborhood and the amount of information to be exchanged among nodes.

The signal processor 306 may include waveform processing and timing functions associated with transceiving data at the node 300. This may include, for example, network timing, time-slot and/or frame-based waveform configuration, maintenance of one or more families of Orthogonal Frequency Division Multiplexing waveform modes (or other transmit mode waveforms), receiver detection of waveform modes, error correction coding, and so forth. In general, the signal processor 306 may be implemented in any suitable combination of digital signal processors, field programmable gate arrays, application-specific integrated circuits, microprocessors, or other general or special-purpose computing devices.

In one embodiment, a family of Orthogonal Frequency Division Multiplexing (OFDM) waveforms may be employed for adaptive data rate communications. The modes of the OFDM waveforms may, for example, include 7.2 MHz Quadrature Phase-Shift Keying (QPSK), 4.8 MHz QPSK, 2.4 MHz QPSK, 1.2 MHz QPSK, 1.2 MHz Binary Phase-Shift Keying (BPSK), or the like. The effective data rate for transmit waveforms may be affected by other parameters such as error correction. In order to facilitate implementation of an adaptive rate system, the transmit modes may be organized into an ordered list of monotonically increasing data rates matched to correspondingly decreasing signal robustness, thus permitting unique mapping of link quality to transmit mode. In one aspect, the actual waveform mode selected to transmit data on a link may be adaptively selected according to any suitable evaluation of link quality for links to neighboring nodes.

The radio 308 in general operates to transmit data from the data queue(s) 310, as organized and encoded by the data link 304 and the signal processor 306 (along with any control information, packet header information, and so forth), over a wireless air interface to other nodes in a MANET, and to perform complementary data reception. The radio 308 may include any radio frequency analog circuitry and the like, and may be coupled to the signal processor 306 which converts data and control information between a digital representation used within the node 300, and an analog representation used in radio frequency communications with other nodes. In embodiments, a low power radio 308 may be employed, such as where the node 300 is a battery-powered mobile device. In other embodiments, a high-power radio 308 may be employed, such as where the node 300 is an access point or backhaul access point connected to a fixed power infrastructure. In an embodiment, the radio 308 and signal processor 306 provide adaptive data rate coding capable of changing transmit modes, error correction, and the like according to measured link quality.

The data queue(s) 310 may include any data for transmission from the node 300. This may include, for example, data from the data sources 302, data that is relayed by the node 300 from other nodes in the MANET, and/or control information scheduled for transmission within data packets from the node 300. The data queue(s) 310 may be organized in any suitable fashion, and may include a single first-in-first-out queue, multiple queues, prioritized queues, and the like. In one embodiment, the node 300 may include multiple prioritized queues to assist in providing various service levels, such as for QoS traffic. In general, data in the data queue(s) 310 is delivered according to any suitable queuing mechanism to the data link 304, signal processor 306, and radio 308 for transmission within the MANET.

Routing information 312 such as a routing or forwarding table may be provided to support routing functions by the node 300. In general, this may include, for example, a destination address or identifier, a cost of a path to the destination (using any suitably cost calculation), and a next hop on that path. Other information such as quality of service and other metrics for various routes and links may also be provided for more refined routing decisions.

Neighborhood information 314 may be maintained in a database, flat file, routing table, or other suitably organized volatile or non-volatile storage within the node 300. The neighborhood information 314 generally supports the creation and maintenance of the MANET as well as routing functions of each MANET node. Within the MANET, each node may interact with other nodes to autonomously identify and maintain local network connections, shift capacity, dynamically form routes throughout the network, and so on. The routing functions of the node (as supported by the neighborhood information 314) may accommodate delay-sensitive (e.g. voice) traffic, delay-tolerant traffic with quality of service (QoS) prioritization, and so on.

The neighborhood information 314 may include an identification of neighboring nodes along with information relating to those nodes. This may include one-hop neighbors (i.e., neighboring nodes in direct wireless communication with the node 300), two-hop neighbors (i.e., neighboring nodes that communicate with the node 300 through only one other node), or any other nodes or participants within the MANET. In one aspect, neighborhood information 314 includes link quality information for the radio 308, which may be obtained from any combination of physical layer and data link data, and may be employed to adapt the data rate of communications according to currently present channel conditions. The neighborhood information may also include QoS data used to select next hops for QoS data. Other useful information may include bandwidth utilization, node weights, node position (either logical or physical), and queue latency for each QoS type and/or other priority type.

In one aspect, the neighborhood information 314 may be gathered during periodic exchanges (such as during control transmissions) with neighboring nodes, which may occur under control of the link manager of the data link 304. For example, the node 300 may determine output bandwidth (i.e., data transmit requirements) for each link that the node 300 has with a neighbor, and may transmit this to one-hop neighbors. Similarly, the node 300 may receive output bandwidth from each one-hop neighbor. Using this data, each node 300 may further calculate its own input bandwidth (i.e., data receive requirements) from each link to a neighboring node, and this information may in turn be exchanged with one-hop neighbors. Following a system-wide exchange with one-hop neighbors, the node 300 (and every other node in the MANET) may calculate a node weight that represents relative output requirements for the node 300. For example, the node weight, W, may be calculated as:

$$W = \frac{{BW}_{out}}{{BW}_{out} + {BW}_{in}} \qquad [ Eq . 1 ]$$

where BWₒᵤₜ is the total output or transmit requirements for each link of the node 300, and BWᵢₙ is the total input or receive requirements for each link of the node 300. Finally, the node 300 may transmit the node weight to each neighboring node, and may in turn receive a node weight from each neighboring node. It will be appreciated that the node weight, W, may be further processed for use with other neighborhood information 314, such as by limiting the value according to the number of bits used for control information, or by providing a supplemental adjustment to the node weight to further refine control of routing or other MANET functions. Sharing of information for maintenance of the neighborhood information 314 may be controlled, for example, by the data link 304, which may apply any suitable technique to determine when to share information with one hop neighbors. In one aspect, the data link 304 may transmit data whenever a change is detected in the MANET such as an addition or deletion of a node.

As noted above, any of the neighborhood information 314, routing information 312, and/or data queue(s) 310, as well as status or other information concerning any of the foregoing, may usefully be shared among the nodes participating in a network, and all such information is intended to fall within the meaning of metadata as that term is used herein.

In another aspect, for a MANET that has location-aware nodes 300 (e.g., using Global Positioning System (GPS) data, signal strength data, and so forth), the neighborhood information 314 may include position data in order to support location-based routing and the like.

Having described a MANET in general terms, the description now turns to a more detailed treatment of enhancements to wireless communications.

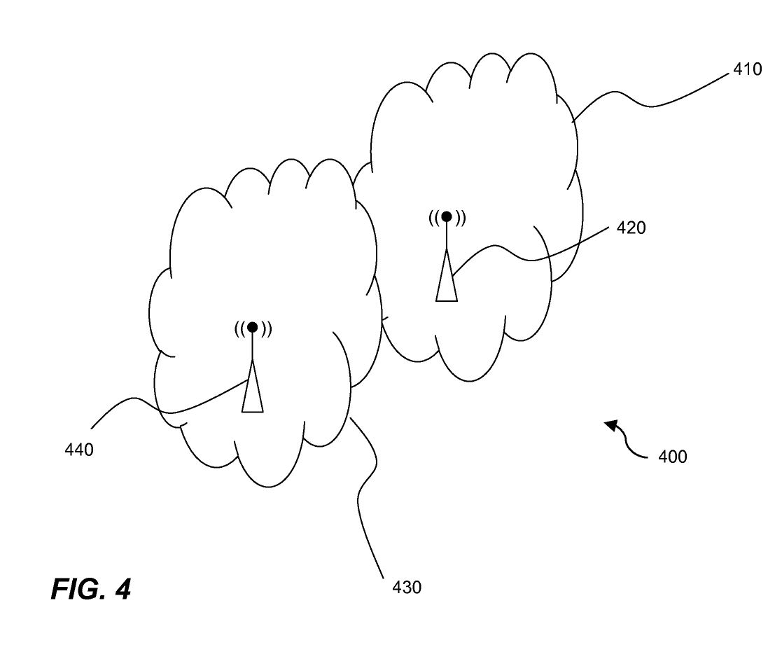

FIG. 4 shows a MANET 400 containing two MANET BAP domains. In general, an arbitrary MANET cloud or BAP domain 410 may be formed around a Backhaul Access Point (BAP) 420 that connects the MANET 400 to another network such as the Internet. A second arbitrary MANET cloud or BAP domain 430 is shown containing another BAP 440. As shown in FIG. 4, MANET BAP domains 410, 430 may intersect each other and BAPs do not need to be at the center of corresponding BAP domains. In general, participation in a BAP domain is explicitly determined by each node, with membership information stored and optionally updated from time to time such as when the node is mobile.

A variety of techniques may be employed to determine membership in a BAP domain, as well as when to switch from one BAP domain to another, as discussed in greater detail below. For example, through neighbor discovery, the various mobile nodes, fixed nodes, access points etc. within a MANET may identify their neighbors and in turn identify paths to the Internet or other fixed network structure(s) through BAPs, with nodes forming a BAP domain around each BAP. Although certain nodes might potentially belong to two or more BAPs based upon network coverage, limiting inter-nodal communication to nodes within a BAP domain can provide a useful abstraction for confining network operations such as routing, multicasting, and so forth to a relatively small and well-defined (or at least, better defined) group of nodes. In certain embodiments, a node might also or instead usefully belong to two or more BAPs although certain features described below are expressly limited to environments where each node exclusively belongs to a single BAP domain. A BAP domain may generally be created around a BAP whenever a BAP is powered up, and various nodes around the BAP may either join the new BAP domain or remain in an existing BAP domain (if any) using any suitable allocation scheme or algorithm. Through communications within a BAP domain, the various nodes within the BAP domain update the BAP domain as needed. For instance, a mobile node may move into a BAP domain region. As information is exchanged with the mobile node, the BAP domain may add the mobile node to the domain. The mobile node may then communicate with the Internet through the BAP associated with the BAP domain, and may engage in communications with other nodes within the BAP domain. Similarly, other characteristics of the BAP domain may be updated through the exchange of information between the various nodes which comprise the BAP domain.

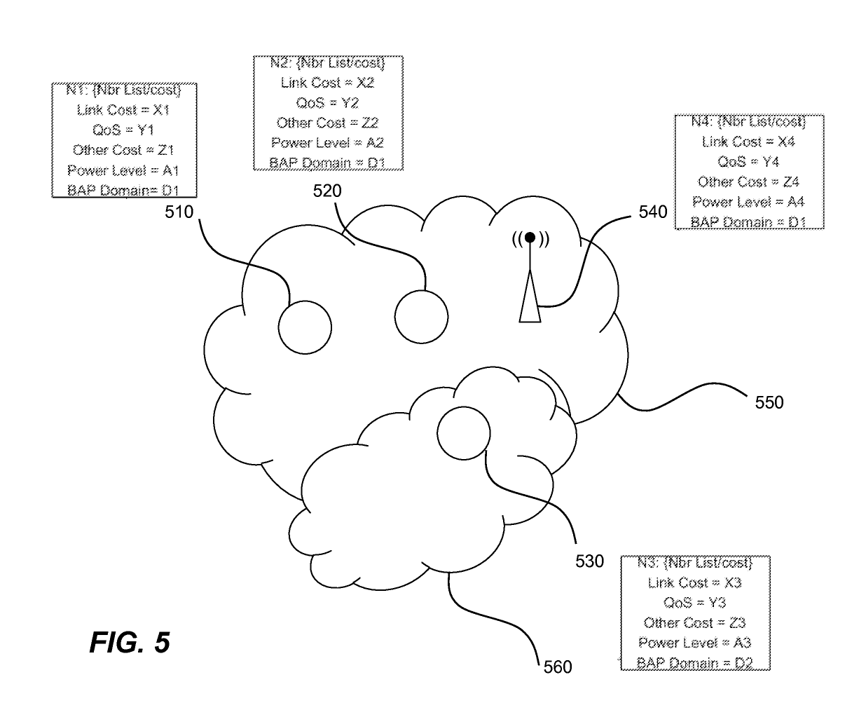

FIG. 5 illustrates information maintained by nodes in a MANET protocol. More specifically, FIG. 5 shows three mobile nodes N1 (510), N2 (520), and N3 (530) and a BAP N4 (540) in a first BAP domain 550. Mobile node N3 (530) belongs to an overlapping BAP domain 560 and co-exists with other nodes N1 (510) and N2 (520). All of these nodes may advertise their link state, per suitable MANET protocols, along with additional information such as link cost, QoS, power level and BAP domains. Mobile nodes may use this information to create different topologies based on different criteria. For example, even between a single sending node and a single receiving node (or multiple nodes in a multicast context) one routing tree, path or the like may be optimized for QoS delivery, while another, different routing tree, path, or the like may be optimized for power consumption. Similarly, the members of a BAP domain may vary according to the criteria used for inclusion.

Mobile nodes may advertise a variety of properties, which may be exchanged among nodes either within or on top of a MANET routing or datalink protocol.

1. Link Cost (as provisioned)

2. Link Cost (as discovered)

3. Route Cost (as provisioned)

4. Route Cost (as discovered)

5. Node Cost (as provisioned)

6. Node Cost (as discovered)

7. QoS (as provisioned)

8. QoS (as discovered)

9. Power usage

10. Hops (cost) to BAP

11. Mobility (vehicular, pedestrian node or fixed)

In one aspect, a network layer in a MANET domain may be used to coordinate a broadcast of router control information within the domain. Router control information may usefully include:
1. Link Cost—any measure of cost for using a particular link
2. Route Cost—any measure of using a route (including number of links, or any sum or other measurement of link costs within a route)
3. Power Cost—any measure of power usage for a route and/or links
4. CPU Cost—any measure of processing required for a route and/or links
5. Configurable Cost—any measure of creating or changing a route or nodes within the route
6. Adaptive data rate (ADR) information—any measure of data rates and/or transmission modes for links of a node or a route

This information may be gathered and maintained within a routing protocol (such as within a network layer) and broadcast at any suitable interval according to the protocol and/or related protocols of a MANET. Each receiving node for the control information may create different routes to a destination based on the various criteria such as power, link cost, etc. Once a MANET routing protocol converges with this additional information, all nodes may have different routing topologies based on these criteria.

This additional router control information may be exploited by tagging network traffic to identify or determine which criteria to use for routing the traffic. For example, all host traffic may be tagged and assigned a set of QoS values based on programmable application awareness logic. This application awareness logic may, for example, determine traffic requirements for a given data flow, e.g. VoIP (or other voice data), an MP3 download (or other audio data download), streaming video, etc. Once traffic is tagged appropriately, relay nodes may use this information, along with the router control information, to route the traffic. For example, relay nodes may decide to route based on power utilization, instead of link cost, to save battery power.

In one aspect there is disclosed herein a MANET routing protocol in which traffic is classified into different traffic types, and an optimized route for each class of traffic type is determined according to a class of service and router control information that is shared within a MANET domain. In another aspect, there is disclosed herein a MANET routing protocol that optimizes battery usage for mobile nodes using router control information that is shared within a MANET domain. The systems and methods described herein may be employed to reduce congestion in the network, and at particular nodes, such as by using different criteria to route different traffic types and/or by identifying multiple equally suitable routes for a particular traffic type within a MANET domain.

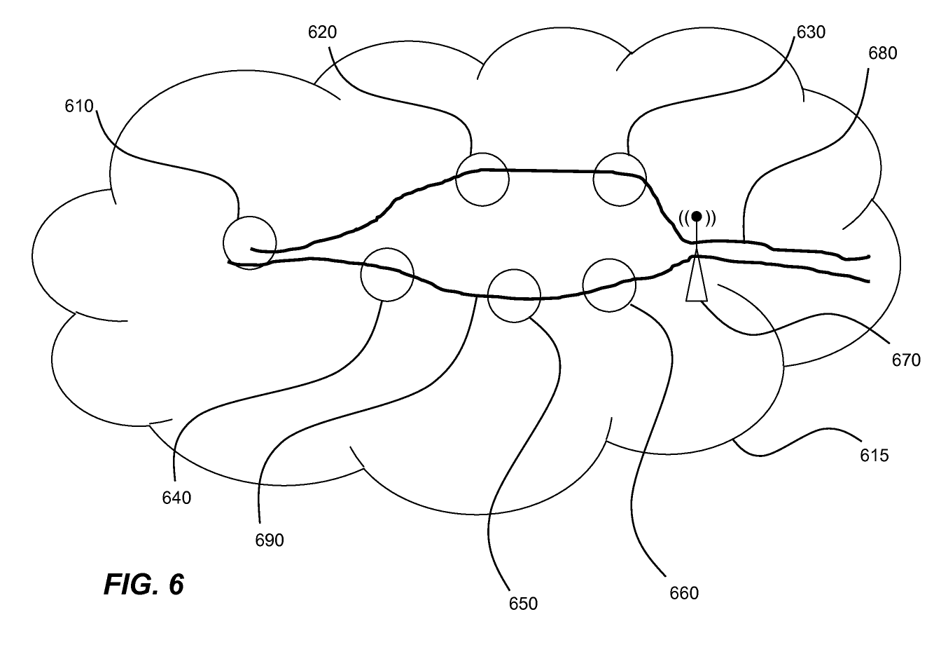

FIG. 6 shows alternative least cost paths 680 and 690 to a backhaul access point 670. Path 680 may traverse nodes 610, 620, and 630 to accomplish a minimum delay path. Path 690 may traverse nodes 610, 640, 650, and 660 to accomplish a minimum power path. Both paths along with the nodes and BAP may reside within the MANET 615. In general, it will be understood that different paths and more generally different network topologies may result from the use of different criteria, parameters, characteristics, and so forth for various nodes, links, and communication types within the MANET. FIG. 6 more specifically shows two different shortest paths to a BAP 670 using optimization of minimum delay versus minimum power usage options as an example. It will be understood that while two paths are shown in FIG. 6, numerous other paths may be provided for different parameters, and that in certain instances, more than one path may have an equal cost.

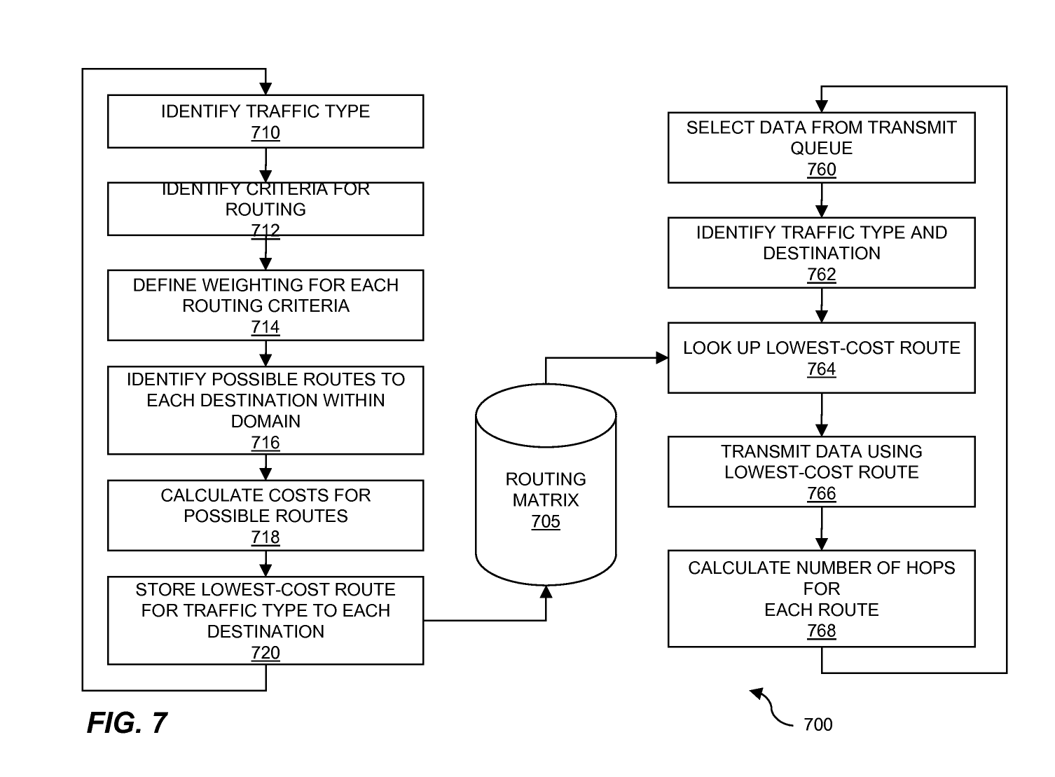

FIG. 7 is a flowchart of a method for implementing cost based routing. It should be noted that the various blocks or steps within the process 700 are illustrative. The exact order may vary and certain steps may be repeated, modified, or omitted without departing from the scope of this disclosure. In general, the process 700 uses an a priori traffic identification and route costing procedure to develop a routing matrix 705. By completely covering all possible destinations and traffic types, the routing matrix 705 can be applied to quickly select routes for outbound traffic from a node in a simple look-up table process. By confining this technique to a single BAP domain and limiting membership in the BAP domain to a suitable number of nodes, the creation of a comprehensive routing matrix 705 for the domain can be reduced to a tractable operation (both in terms of computation and network overhead) for a typical MANET node.

As shown in step 710 a traffic type for network data may be identified. This may include identifying traffic types that are predetermined at an infrastructure level (e.g., hard-coded into a node before it enters the MANET), advertised for a particular BAP domain (such as by the BAP), determined by querying other nodes in the BAP domain, or identified on an ad hoc basis by a node by inspecting traffic passing through the node. In another aspect, traffic types may be identified using Differential Services (as described in Internet Engineering Task Force (“IETF”) Request for Comments (“RFC”) 2475) or other similar Layer 3 or higher QoS mechanisms. Various traffic types may travel through a MANET including VOIP, streamed data (such as streaming audio or video), MP3 data, file transfers, electronic mail, web information, intra-MANET peer-to-peer traffic, MANET node information, and so forth, and each traffic type may be handled in a different manner to provide differing service levels to different traffic types ranging from guaranteed service for critical network traffic to best-effort service for non-critical traffic such as web browsing from a MANET node. It will be understood that the traffic types may be internally represented as specific types (e.g., VoIP, streaming video, etc.) or as generic types (e.g., type 1, type 2, etc.) without departing from the generality of this description. In general and as described below, each node may cooperate in providing various levels of service either implicitly (such as through route costing) or explicitly (such as by prioritizing transmission from a node). The plurality of traffic types may include one or more Quality of Service levels. The plurality of traffic types may include one or more prioritization levels. The plurality of traffic types may also include one or more of host traffic, voice data, audio download data, streaming video, and binary information.

As shown in step 712, criteria for routing may be identified. Some criteria include power, bandwidth, delay, delay jitter, packet loss rate, link quality, latency, QoS, data rate, traffic type, distance (e.g., hop count), and avoidance of congestion, although it will be appreciated that a wide variety of suitable routing metrics are known and may be adapted to use as criteria in the systems and methods described herein. The criteria may include one or more items selected from a group of power usage by a node, mobility of a node, CPU processing requirements, configuration requirements, congestion at certain nodes, and adaptive data rate (ADR) information. The criteria include one or more of a power level, a link quality, a node bandwidth, and a number of hops. These criteria may be automatically detected based on the traffic type identified in step 710, or provided as a predetermined set of criteria that may be, e.g., hardcoded into a node, obtained from neighboring nodes, obtained from a BAP, or specified by a human or computer user. In another aspect, the criteria may be selected according to various objectives associated with a traffic type. For example certain nodes may want to limit their availability to relay data based on the mobility of the node or based on a limited amount of battery life remaining, leading to different criteria that might be employed to assign cost to routes through the MANET. In general multiple criteria may be used in a costing algorithm or the like for evaluating routes through the MANET for different traffic types. It will be understood that terms such as “identify” or “identifying” as used herein are intended to refer broadly to any techniques for obtaining routing criteria for the costing and other algorithms describe below. This may include retrieval of criteria from memory within a node, retrieval from an external resource (such as a BAP or edge router), or specification by a computerized or human user.

As shown in step 714, weighting for each of the criteria may be defined for the traffic type, which may include retrieving weights from a memory, calculating weights based on any number of environmental factors, receiving weights from an external source such as another node, a BAP, or an edge router for a BAP domain, receiving manually-specified weights from a human or computer user, and so forth. For each of the criteria the weighting may permit emphasis, de-emphasis, elimination, or other weighted handling of certain criteria. For example, where power conservation or reduction is important, any power usage criteria may be more heavily weighted than other criteria. As another example, where data rates or delivery times are critical, a delay criterion may be more heavily weighted and power usage may be de-weighted. Certain criteria may be deemed to be irrelevant and therefore the weighting may be small or even set to zero for that criteria. Weighting may vary from traffic type to traffic type and may also vary with other network conditions such as changes to the MANET topology. In general, the steps may include identifying criteria and weightings for a multivariate route cost calculation for each of a plurality of traffic types. The weighting for one or more of the criteria is chosen by a user.

As shown in step 716, the process may include identifying possible routes to each destination within a backhaul access point routing domain. Possible routes to each of the possible destinations through the MANET may be identified. In certain cases a subset of possible routes may be identified. For example, where node-to-node traffic is expected to be minimal, route selection may focus on routes that reach a BAP for a BAP domain, and by extension, all destinations outside the BAP domain. As another example, routes including more than a certain number of hops may be excluded. Any other suitable algorithm or heuristic may be suitably employed. For example, for high-priority traffic types (such as, e.g., VoIP), any link that does not meet a data rate, link quality, or latency threshold may be excluded from use in possible routes. As another example, for low-priority traffic any nodes having a power reserve below a predetermined threshold may be excluded. It will be appreciated that these considerations may also be adequately addressed through an appropriate costing algorithm; however, by identifying conditions that merit outright exclusion up front, the computational demands in maintaining the routing matrix 705 may be reduced.

As shown in step 718, the process may include applying the multivariate route cost calculation to determine a lowest-cost route to each destination within the backhaul access point routing domain for each one of the plurality of traffic types thereby providing routing data. Each of the possible routes identified may have their respective costs calculated. In general, this may include any suitable technique for route costing including for example an evaluation of a weighted, multi-variate cost function for each route using the weights and criteria described above. Based on the criteria and weighting the cost of each route from each source to each destination may be calculated for a traffic type. The plurality of traffic types may include Voice over Internet Protocol and the weightings for the multivariate route cost calculation may be selected to minimize a number of hops to each transmit destination.

As shown in step 720, the process may include storing the routing data in a routing matrix accessible by traffic type and destination. A lowest-cost route from each source to each destination may be stored in the routing matrix 705 for each traffic type. This data may be stored in a manner that is indexed by traffic type, source identifier, and destination identifier, so that a node with data for transmission can quickly look up routing information without further calculations or overhead. The process 700 may then return to step 710 where a new traffic type is identified. In general, the foregoing steps may be performed serially or in parallel for each traffic type. It will be further appreciated that the process 700 may be repeated periodically in order to update routing information as changes occur to network topology, network traffic demands, network conditions (e.g., link quality, battery power for nodes, etc.) and the like. The process 700 may be repeated periodically (e.g., on a fixed or variable schedule), continuously (e.g., repeating as soon as all traffic types have been analyzed for lowest-cost routes), or based upon some trigger event such as change detected in the network topology, node conditions, and so forth, or the appearance of a new traffic type within the MANET. In one aspect, one or more next-lowest-cost routes may be evaluated and stored in the routing matrix 705, which may for example, be used to provide an alternate route to the destination in the event of a failure.

The routing matrix 705 may store the information about the lowest-cost route for each type of traffic as described above, and may be organized or indexed for retrieval of data by source node identifier, destination node identifier, and traffic type. The routing matrix 705 may be suitably organized as a relational database or the like, and may be realized in any form of volatile or non-volatile memory suitable for use in a node. The process may include updating the routing matrix using a scoped link state routing algorithm.

As shown in step 760, data may be selected from a data source such as a transmit queue of a node for transmission. The data source of the node may include multiple queues, and each queue may have multiple transmit modes that use different coding schemes and/or provide different data rates. Based on various MANET topologies, differing queuing may be allowed or permitted.

As shown in step 762, the process may include identifying a transmit traffic type and a transmit destination for data in a transmit queue. The traffic type for the data to be transmitted may be identified. This may include reading a traffic type identifier in header information for the data, or inferring a traffic type based on the content, the source, the destination, a relationship to other data in the queue, or any other available data. The possible types correspond to the types evaluated in step 710. If a new type of data is encountered then the MANET (or the node) may trigger an update to the routing matrix 705 as previously described so that lowest-cost routes for the new traffic type can be evaluated and stored in the routing matrix 705. The source and/or destination of the traffic may also be identified. In one aspect, the system may only employ destination information, with suitable adaptations to the process 700 described herein.

As shown in step 764, the process may include looking up the lowest-cost route to the transmit destination for the transmit traffic type in the routing matrix. The routing matrix 705 may be used to look up a lowest-cost route for the data. The lookup may include the data traffic type, the data source, the data destination, and any other information useful for identifying and/or retrieving lowest-cost routes from the routing matrix 705.

As shown in step 766, the process may include transmitting the data to the transmit destination according to the lowest-cost route. The transmit destination includes a backhaul access point for any destination outside the backhaul access point routing domain. Data may be transmitted using the lowest-cost route. In general, this includes delivering the data from the data source to the radio for transmission to a neighbor node using a specified transmit mode. The lowest-cost route may be dependent upon a variety of criteria and weights as generally described above. In one aspect, unsuccessful transmissions may be detected, and a next-lowest-cost route may be retrieved from the routing matrix 705. A variety of failure mechanisms may further be provided, such as a triggering a complete route cost analysis or destination node detection, when all routes to the destination fail.

As shown in step 768, the number of hops on a given route may be calculated. While a number of hops may be employed as a criterion in route costing as described above, the number of hops may also be used independently at the time of transmission as a limit or threshold for route selection. Thus, for example, if the number of hops exceeds a predetermined threshold for a traffic type, any number of exceptions may be applied such as selecting a next-lowest-cost route, requesting an update to route costs, delivering an error message and so forth. While step 768 is depicted as occurring after a transmission of data in step 766, it will be understood that an independent hop count analysis may be usefully performed at other times during the process 700, such as immediately after data is selected from a transmit queue or immediately after a traffic type is identified (which may determine the hop count threshold). All such variations are intended to fall within the scope of this disclosure.

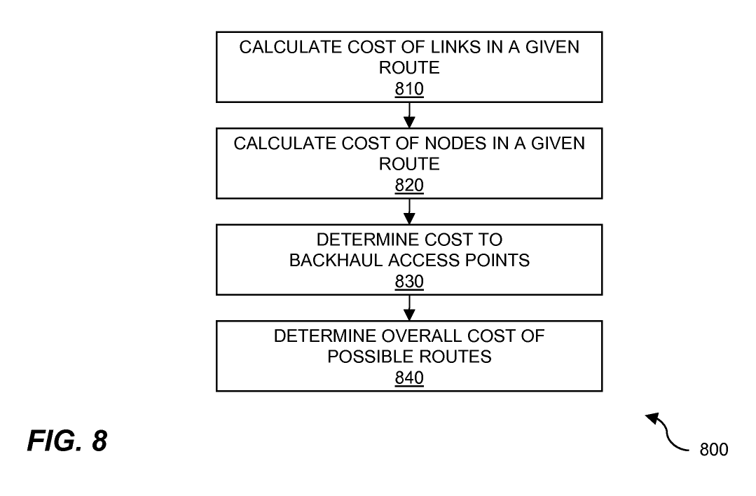

FIG. 8 is a flowchart of a method for determining route costs to a backhaul access point. Where the majority of traffic within a BAP domain or the like is expected to travel through a backhaul access point, this type of route costing may be particularly useful, and may be performed independently of other routing analysis within the BAP domain.

As shown in step 810, the process 800 may begin with calculating a cost for each link in a route. As shown in step 820, a cost may be calculated for each node used in a route. As shown in step 830, a cost may be determined to reach a BAP. As shown in step 840, an overall cost for possible routes may be determined. The calculation may include all of or only a subset of the cost of each link, the cost of each node, and the cost to a BAP, for each route evaluated.

Various factors may influence the cost of routes. As a significant advantage in mobile ad hoc networks, network traffic can be further dynamically managed using techniques by simply adding or removing BAPs. Because the MANET BAP domains can self-form, BAPs may be added without a site survey or other planning Traffic may be routed off the MANET by the simple, physical addition of a BAP. It will be understood that, for MANET routing, various types of cost information may be shared among nodes and used to determine routes within a MANET and/or a BAP domain. An optimum path through a mobile network may be calculated by utilizing different types of cost/QoS information over any MANET using routing protocol and by utilizing backhaul domain management.

In one aspect, nodes may provide parameters to minimize or optimize cost in a MANET routing algorithm, e.g. route/link cost, QoS, power level, etc. Through an exchange of neighbor data within a BAP domain, other nodes may see MANET routing information as described above, along with these parameters, and determine the minimal cost. For instance, a node that advertises it is a low power device may not be best choice for certain routings even though the device has better link/route cost.

In another aspect, nodes may use all the information provided by a MANET routing protocol, along with extra information, to determine optimum network routes. Nodes may create multiple paths to their destination based on different criteria (as stated above).

In another aspect, multiple MANET BAP domains may be created when additional BAPs are deployed. The MANET BAP domain concept is loosely comparable to the cellular “cell” concept where multiple mobile nodes “belong” to a fixed network element that is connected to another network infrastructure; however there are significant differences. In a MANET, the BAP domain is a logical construct with inclusion in (or exclusion from) a particular domain being a matter of negotiation between various nodes and a backhaul access point. Further, unlike a cellular system, membership in the BAP domain does not signify a direct communication link with the backhaul access point. Rather, membership in the BAP domain signifies that a node can reach the backhaul access point, either directly or through one or more intermediate nodes that are also members of the BAP domain. In general, these routes to other networks represent the best path through the multi-hop wireless MANET to reach a suitable BAP. Further the BAP domain has further significance within the MANET, and may serve to limit the scope of MANET routing protocol updates, neighbor information exchanges, peer-to-peer data communications, and so forth. Once MANET BAP domains are created, they may provide a backhaul exit point for MANET traffic. The MANET BAP domains may work together with other MANET BAP domains and MANET routing protocols. This may advantageously provide information on alternate routes in the event of a backhaul failure. The MANET BAP domains may be automatically created with adjustable boundaries when backhaul access points are deployed, thus adding capacity without requiring a site survey and/or re-provisioning of an existing system. In general, some or all of these factors may be accounted for when seeking to optimize routing within a wireless ad hoc network.

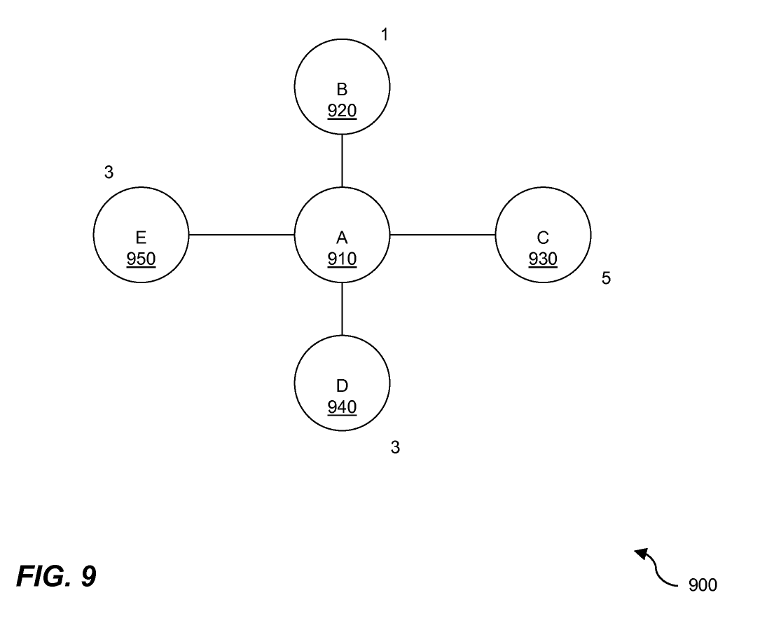

FIG. 9 shows a number of nodes in a MANET 900. A transmit mode is also shown for each node for purposes of discussing Receiver Oriented Multicast techniques that may be used within a MANET. Receiver Oriented Multicast (ROM) is a modified version of the On-Demand Multicast Routing Protocol (ODMRP) with three significant changes. First, ROM is Receiver Oriented rather than Sender Oriented. That is to say that the receivers in a multicast group initiate the process of forming the multicast routes. Second, ROM constructs a multicast tree, whereas ODMRP is a mesh protocol. Third, ROM does not generally operate in On-Demand mode, but instead sets up multicast groups and then maintains them on a periodic basis. ROM may reduce overall control message traffic on the network when a network has more source nodes than receiver nodes. This reduction in traffic is because the ROM protocol floods Join Request Packet (JRP) control packets from the receivers of a multicast group rather than from senders. If there are 21 nodes in the network, with 20 nodes as senders and 1 node as a receiver, then there will be one JRP flood versus 20 JRP floods with ODMRP. It will be understood that the systems and methods described herein are not limited to wireless networks using ROM or ODMRP, and that the principles may more generally be applied to any multicast protocols having similar features that can be suitably combined with the other aspects of the following description.

In example 900, node A 910 is connected to node B 920, node C 930, node D 940, and node E 950 with their modes listed next to each node (1, 5, 3, and 3 for node B, node C, node D, and node E respectively). When node A broadcasts information to node B, node C, node D, and node E, the least common mode is 1, so a broadcast packet may be put on the Mode 1 queue of node A. When node A wants to multicast a packet to node B, node C, node D and node E (assuming they all are in a multicast receive group for node A), node A may copy the packet to queues for Modes 1, 3 and 5. This copy may be done using smart pointer reference counts in order to reduce actual copying of the packet. It will be understood that the modes described herein may, for example, include the OFDM waveform modes described above or any other waveforms using different data rates, encoding schemes, or the like.

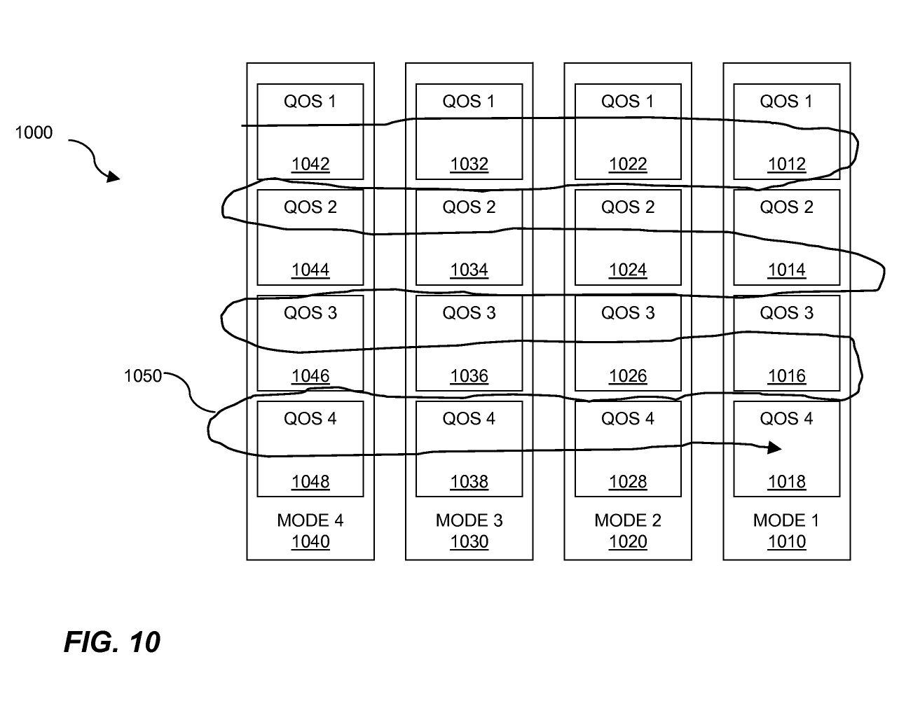

FIG. 10 shows multiple mode queues 1000 within a node for transmitting data that support different levels of QoS. Enqueued packets may be added to the queue according to Mode (with modes 1 through 4 illustrated) and QoS (with QoS 1 through 4 illustrated). In order to determine the transmit mode, queues may be traversed 1050 across all modes for highest QoS, then decreasing QoS across the Modes and so on to find the first non-empty queue. A slot for outbound data may then be filled with data from this queue until the slot is full. If additional slot capacity remains, the slot may be filled with lower QoS packets from the same Mode queue. When a set of nodes form a multicast group, they may use their data link mode queues to send multicast traffic. Multicast traffic may use the most common, highest mode queues to send the traffic, which may reduce traffic replication by each node because all one hop neighbors supporting that mode can see the traffic at the same time. Use of the highest mode queue may help to ensure that multicast traffic travels at a relatively high rate through the MANET without overwhelming nodes to replicate traffic for different nodes. It will be appreciated that while four QoS levels and four modes are depicted, any number of modes and QoS levels may be used without departing from the scope of this disclosure.

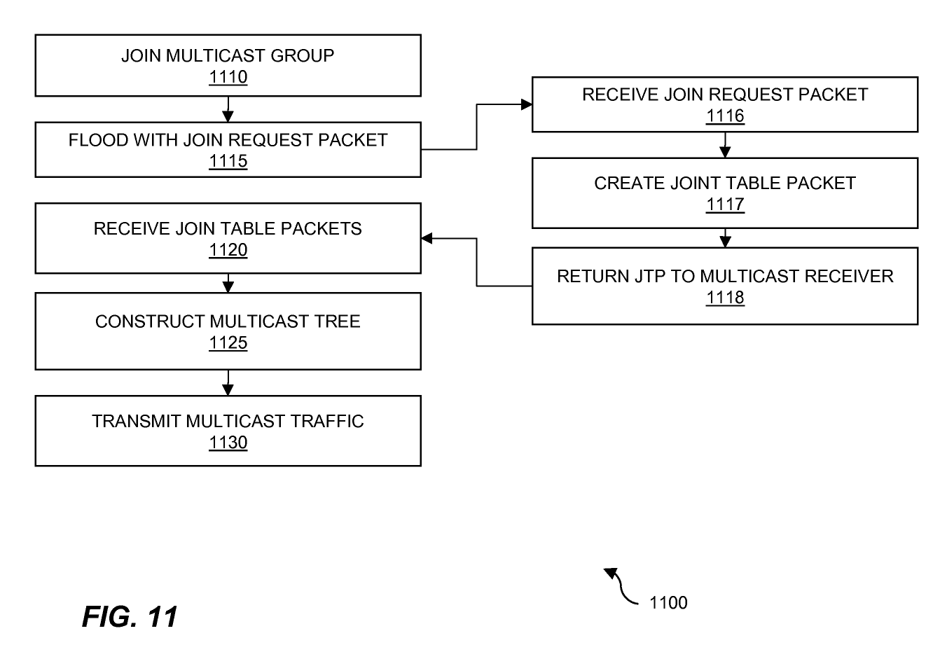

FIG. 11 is a flowchart of a method for performing multicast routing. In one aspect, a forwarding group may be created and maintained as described herein in order to route multicast traffic in a MANET.

As shown in step 1110, the process 1100 may include joining a multicast group within a wireless ad hoc network as a receiving node for multicast traffic. This may, for example, include broadcasting a message to any neighboring nodes with a flag or other indicator requesting a join. This message may be forwarded until it reaches, e.g., a forwarding node in a multicast group (which may be an immediate neighbor of the node) at which time the node is added to the multicast group, such as by initially assigning the forwarding node as responsible for forwarding packets to the new node. A variety of join techniques are known and may be suitably adapted to a node joining a multicast group in the methods and systems described herein.

As shown in step 1115, the process may include flooding the multicast group with a Join Request Packet (JRP) from the receiving node. The receiving node (and any other receiver nodes belonging to the multicast group) may then flood the network with JRPs. It will be understood that a second receiving node, or any number of additional receiving nodes, may flood the multicast group at the same time or subsequently to the first receiving node. The process may include joining the multicast group from a second receiving node and flooding the multicast group with a JRP from the second receiving node. The process may include updating the multicast group and may include exchanging information within the multicast group about link quality.

As shown in step 1116, a node sourcing multicast data may receive the JRP. The process may include receiving a Join Table Packet (JTP) from a sending node within the multicast group that receives the JRP, the JTP returned to the receiving node along a path travelled by the JRP to the sending node and the JTP identifying one or more mode queues having different data rates for each node along the path. The sending node may create a corresponding Join Table Packet (JTP) as shown in step 1117, and may transmit the JTP back towards the multicast receiver node through the same path as the JRP traversed, as shown in step 118.

As shown in step 1120, the receiving node may receive one or more JTPs from one or more sending nodes within the multicast group that received the JRP. Each of the one or more JTPs may be returned to the receiving node along a path travelled by the corresponding instance of the JRP. Each JTP may identify one or more mode queues for each node along the path (which may be identified in neighbor data for various intermediate nodes, or added by each intermediate node as it forward the JTP). The nodes that are part of the path between receivers and senders may be designated as forwarding nodes in the forwarding group for that particular multicast group's traffic. The process may include receiving a plurality of JTPs from a plurality of sending nodes and constructing a multicast tree based upon the plurality of JTPs

As shown in step 1125, the process may include constructing a multicast tree for forwarding multicast traffic within the multicast group based upon the JTP. The multicast tree may be constructed for forwarding the multicast traffic.

As shown in step 1130, the process may include receiving a multicast message according to the multicast tree, the multicast message received by the receiving node using a highest mode available queue of the one or more mode queues for each node within the multicast group. Multicast traffic may in turn be transmitted according to the multicast tree using a highest mode available queue of the one or more mode queues for each node within the multicast group. The highest mode available queue may be a most common highest mode available queue within the multicast group. The multicast message may be prioritized according to a quality of service. The quality of service may include a highest quality of service for prioritizing data across all of the one or more mode queues. The quality of service includes a highest quality of service for which all such data is transmitted from all of the one or more mode queues before a next quality of service data is transmitted from any of the one or more mode queues. The multicast traffic to be transmitted may also be copied from the highest mode available queue to a lower mode queue in at least one intermediate node between the sending node and the receiving node.

In one aspect, MANET domains (e.g., groups of nodes) may be employed to limit the scope of each multicasting network thus partitioning the multicast traffic. Backhaul Access Points (BAP) may also, or instead, be employed to handle backhaul multicast traffic to other BAP domains (e.g., groups of nodes sharing a backhaul access point) that should receive the multicast traffic, further optimizing multicast traffic.

The process 1100 may usefully improve a mobile node's capability to join a multicast group and send/receive multicast traffic in a MANET. In general, a forwarding group for multicast data may be maintained through the periodic, complementary operations of join request packets flooded from receivers in an existing forwarding group, and responsive join table packets from multicast data senders. A forwarding group may be formed of the nodes between the senders and receivers. In another aspect, multicast transmissions may be optimized using waveform modes, and more particularly common modes among a group, to minimize sender resources. The scope of multicast traffic may also be controlled and optimized using MANET domains and BAP domains.

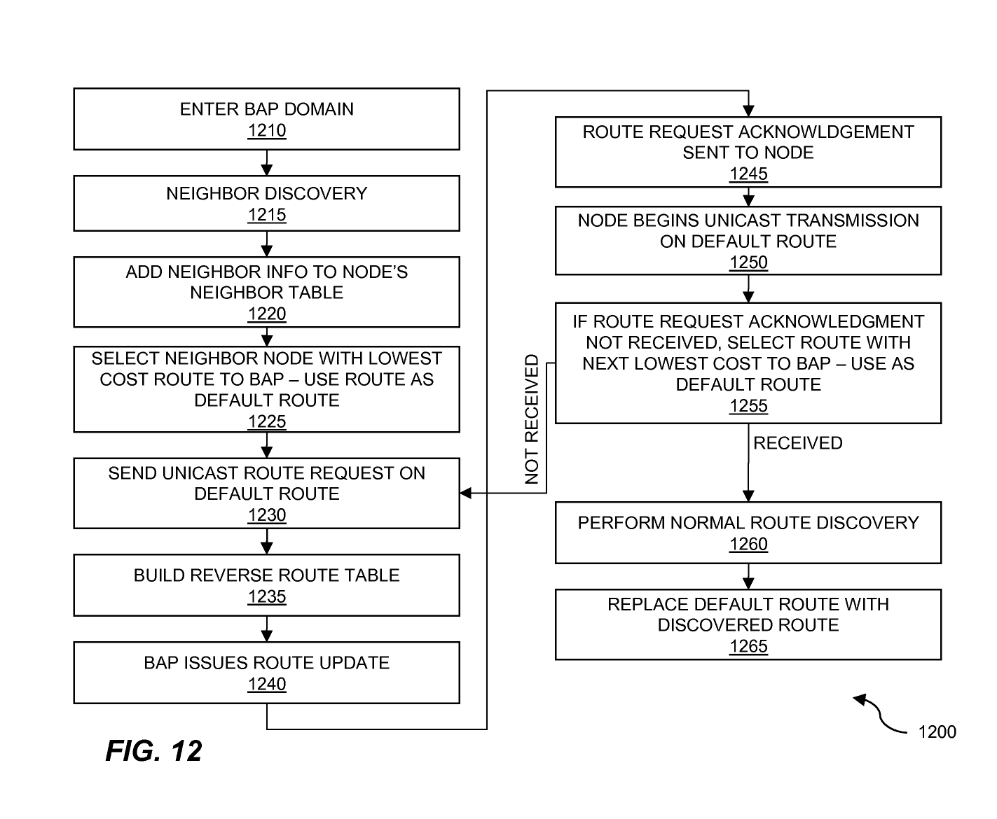

FIG. 12 is a flowchart of a method for providing fast entry to a backhaul domain. It may be advantageous for mobile nodes to quickly establish a bi-directional route to a backhaul access point in order to access core networks and to begin sending and receiving user data and routes for other nodes requiring backhaul access. This may be particularly important when the mobile node crosses BAP domain boundaries where connectivity to the core network(s) might be temporarily lost, or when a node is first powered up or otherwise enters a BAP domain.

As shown in step 1210, a node may enter a BAP domain, such as when a node powers up or boots, or when a node initially enters a BAP domain such as upon exiting a neighboring BAP domain. At the time of entry into the BAP domain, the node may have no knowledge about its neighborhood, about a routing path to a BAP, or about previous operation.

As shown in step 1215, the process may include discovering one or more neighbor nodes to a node in the wireless ad hoc network. The discovering may occur when the node is powered up. The discovering may occur when the node is mobile and moves locations where the node has one or more new neighbor nodes. The node may begin neighbor discovery to obtain information about a neighboring nodes. This may include the identity of all nodes in a neighborhood of nodes, as well as information about individual nodes that might be used in route costing and other network functions. For example, an exchange of information among nodes in a neighborhood may provide information for one or more neighbor nodes such as transmit requirements (e.g., an amount of outbound data in transmit queues), congestion, link quality, available transmit modes, etc.

As shown in step 1220, the process may include obtaining information on the one or more neighbor nodes and storing the information in a neighbor table for the node. The node may store information discovered about its neighbors in memory as a neighbor table or the like. In one aspect, the discovered information may include a route cost to a backhaul access point that services the neighborhood.

As shown in step 1225, the process may include determining which of the one or more neighbor nodes has a lowest-cost route to a backhaul access point. The process may further include selecting the lowest-cost route from the one or more neighbor nodes as a default route from the node to the backhaul access point. The node may select a route to the backhaul access point from a neighbor node to use as a default route to the backhaul access point until the node has an opportunity to calculate or otherwise determine its own lowest-cost route to the backhaul access point. The default route may, for example, be a route through the neighbor that has the lowest-cost route to the backhaul access point.

As shown in step 1230, the node may send a unicast route request message on its default route to the BAP. The neighbor node with the lowest-cost route may receive the route request message and forward the route request message along the default route towards the backhaul access point.

As shown in step 1235, the process may include building a reverse route table along the default route at one of the one or more neighbor nodes which is a part of the default route. A reverse route table for the requesting node (the node that recently joined the BAP domain) may be built at each node as the unicast route message traverses the network to the backhaul access point, and the address resolution protocol (ARP) table cache may be updated based upon the route request message.

As shown in step 1240, the process may include issuing a route update from the backhaul access point. Once the route request message reaches the BAP, the BAP may issue a route update to the core router or other network infrastructure (using different any of a variety of techniques such as OSPF advertisement, Gratuitous ARP, Mobile IP updates, etc.), and may send a route request acknowledgement back to the initiating node.

As shown in step 1245, the process may include sending a route request acknowledgement from the backhaul access point to the node. The initiating node may receive its route request acknowledgment from the BAP and may begin routing immediately using this default route or “fast route” (with fast referring to the manner in which the route was determined rather than the data rate or other metrics for the route).

As shown in step 1250, the process may include sending a unicast route request from the node on the default route. The initiating node may begin unicast transmission on the default route. The process may include transmitting data to one of the one or more neighbor nodes for communication to the backhaul access point according to the default route.

As shown in step 1255, if no route request acknowledgment is received within a configurable time period, the node may initiate a new route request message using another path as the default route. The default route may be modified to a different route than the lowest-cost route from the one or more neighbor nodes. The default route may be modified because a route request acknowledgement is not received from the backhaul access point and the different route is a next lowest-cost route from the one or more neighbor nodes. The new route may be the next lowest-cost route to a BAP. This next lowest-cost route may be from the same neighbor node or it may be from a different neighbor node of the initiating node. Flow of operation may branch to step 1230 to send a unicast route request on the new default route.

As shown in step 1260, the process may include performing a route cost analysis to determine a lowest-cost route from the node to the backhaul access point and replacing the default route with the lowest-cost route from the node to the backhaul access point. Normal route discovery may be performed. This route discovery may determine the lowest-cost route to a BAP using any route cost analysis described above. It will be appreciated that a full route discovery or analysis may be performed in parallel with the default route discovery and usage or after the default route has been selected.

As shown in step 1265, once a lowest-cost route is determined with a route cost analysis or any other technique for route selection, the default route may be replaced with this lowest-cost route.

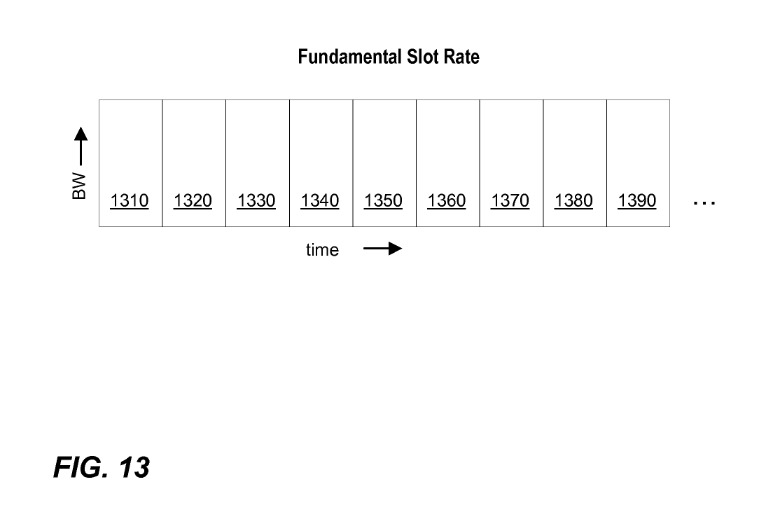

FIG. 13 shows a TDMA time slot structure that may be used in a MANET. In general, the TDMA time slots 1310, 1320, 1330, and so on can be loosely partitioned into different ‘roles’ that correspond to the intended purpose of the time slot. At a high level, slots may be divided into ‘control’ and ‘data’ slots for their primary role, though the role may be adapted for neighborhood discovery and maintenance (NDM), such as where a data slot is used to send control information. Control slots may be further partitioned into ‘network entry’ and ‘scheduled’ control slots. Network entry control slots may be contention-based to provide random access for nodes that wish to join the network. In order for new nodes to contend for these time slots in the MANET, each node may maintain a random backoff counter. When the counter reaches zero, the node may transmit on the next available network entry control slot and re-set the random backoff counter. The node may dynamically reset its backoff counter to a value based on the size of its local neighborhood or other information. Scheduled control slots may provide an opportunity for nodes that are already in the network to send updated information about their local neighborhood. Many different scheduling protocols are known and may be suitably adapted for use with the Scheduled Control Slots. For example, the nodes may employ a Node Activated Multiple Access (NAMA) protocol for distributed channel access over a two-hop neighborhood. On average, each node in the two-hop neighborhood transmits once every N2 scheduled control slots where N2 is the size of the two-hop neighborhood. In this manner, the available control slots are evenly distributed according to the neighborhood size. Additionally, in order to maintain timely neighborhood updates when the neighborhood size grows, data slots may be converted into control slots. Each node maintains a counter indicating how many slots have passed since the last time the node transmitted a scheduled control slot. If a configurable threshold is exceeded for a number of time slots which have passed since the node has transmitted, the next data slot for that node may be converted into a scheduled control slot. This capability provides scalability to increased neighborhood sizes without requiring excessive overhead for smaller neighborhoods. As discussed, in a MANET running TDMA, transmissions typically occur aligned with individual time slot boundaries. Likewise, a scalable neighbor discovery and maintenance protocol in the data link layer may obtain local neighborhood knowledge for nodes in a MANET.

It will be understood that an ad hoc network such as a MANET may lack a centralized time source that provides a fixed time base for TDMA or other time-slotted or time-multiplexed data transmissions. In such environments, a third-party resource may provide a timing reference, such as a GPS system, a Global Systems for Mobil communications (“GSM”) system, an IEEE 802.16 (“WiMax”) wireless network, or any other reliable timing reference. In other embodiments, nodes in the network may self-synchronize to one another as described for example in U.S. application Ser. No. 12/418,363 filed on Apr. 3, 2009 and entitled “Methods and systems for a mobile, broadband, routable Internet”, the entire content of which is incorporated herein by reference.

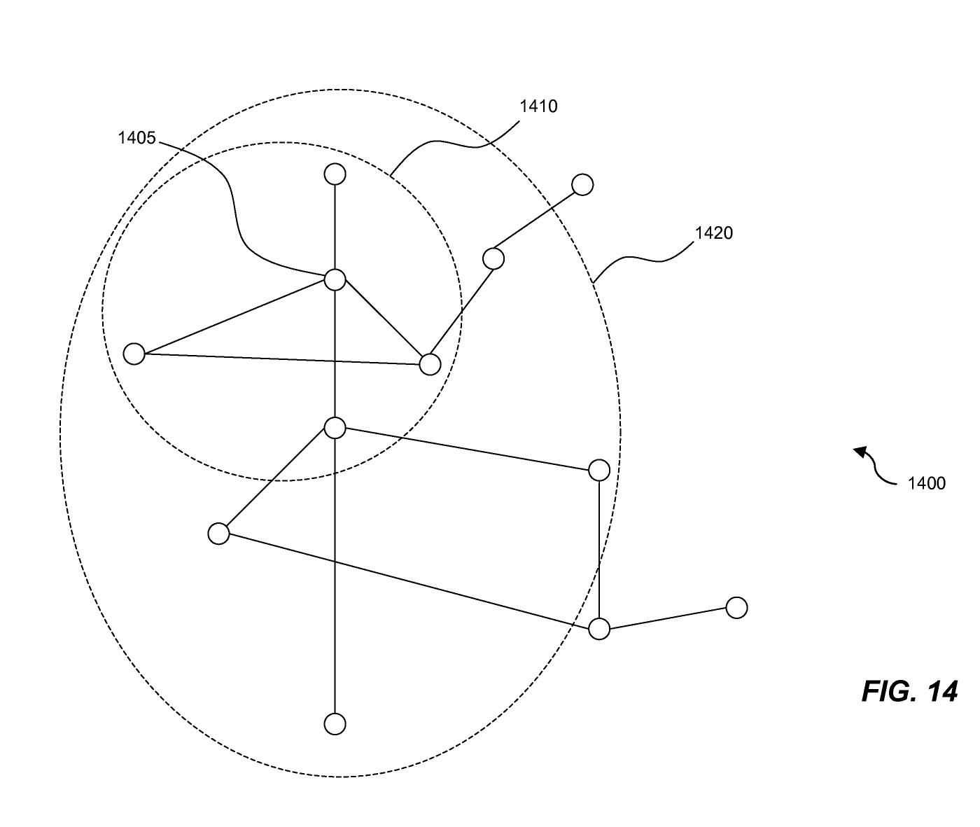

FIG. 14 shows a topology 1400 for a MANET having one-hop and two-hop neighbors. The neighbor discovery and maintenance protocol may run in each node to allow the node to develop and maintain its view of the local one-hop and two-hop neighborhood. A node's one-hop neighborhood 1410 may include all of the nodes that it can reliably communicate with directly over a single radio link. Similarly, the two-hop neighborhood 1420 may include all nodes that can be reached in two hops or less. In either case, the neighborhood typically includes the node itself which is zero hops away within the neighborhood. For example, in the depicted topology 1400, node 1405 has a one-hop neighborhood 1410 with four other nodes and a two-hop neighborhood 1420 with eight other nodes.

As part of neighbor discovery and maintenance, each node may maintain a neighbor table which may be stored in the memory of each node with entries for each one-hop neighbor. Each entry for a neighbor may contain the following information:
Node ID
Received Link Quality
RSSI—received signal strength
SNR—signal-to-noise ratio
Transmitted Link Quality
Received Packet Counter
Expected Packet Counter
Suggested Link Data Rate (to send)
Suggested Link Data Rate (to receive)
Actual Link Data Rate (to send)
Actual Link Data Rate (to receive)
Node Weight (i.e., an indication of required scheduling priority)
Indication of timing reference stability
Device type (e.g., Access Point, Backhaul Access Point, Subscriber Device)
Domain ID (i.e., indication of how to reach fixed network)
Domain Cost (i.e., indication of how close node is to the fixed network)
Indication of routability (i.e., indication of “cost” for other nodes to route data through this node)
Acknowledgement (i.e., indication that the neighbor includes this node in its neighbor table)
Transmit Power—required transmit power to reach this neighbor
Link Cost (i.e., indication of relative cost of sending data over this link)
One-hop neighbors—the one-hop neighbors of the node's one-hop neighbors (used to form two-hop neighborhood)
Other information about the two-hop neighbors (e.g., Node Weight)
Any other information about the neighbor

The neighbor table may more generally track any useful parameters for each of a node's neighbors to assist in an efficient use of the MANET. A link quality indicator may be used, for example, to track how well the node is receiving transmissions from a neighbor. The expected number of control receptions during a specified time interval from the neighbor may be calculated from the schedule and compared with the actual number of receptions. Based on the comparison, the link quality of the neighbor may be either incremented, left constant, or decremented. When the node receives a control message from a node that is not in its neighbor table, it may create a new entry and assign a low link quality. If it continues to receive transmissions from the node, the link quality may be progressively incremented. Once link quality exceeds a specified threshold, the node may inform its router of a new link for sending data. If node mobility causes a node to move out of range, the link quality may be progressively decremented since no transmissions are received. Once the link quality reaches zero, the node may be removed from the neighbor table.

In order to build the entries in the neighbor table, nodes may transmit control messages that contain a subset of the information in its one-hop neighbor table. The received information in the message along with the metadata associated with packet reception may then be used to update the entry or entries in the neighbor table that correspond to the transmitting node. For efficient channel access, nodes may choose to transmit only a subset of the information in its neighbor table so that the transmission does not exceed the payload capacity of a single time slot. In networks that support an adaptive data rate (ADR), control messages may be sent using the most robust waveform mode.

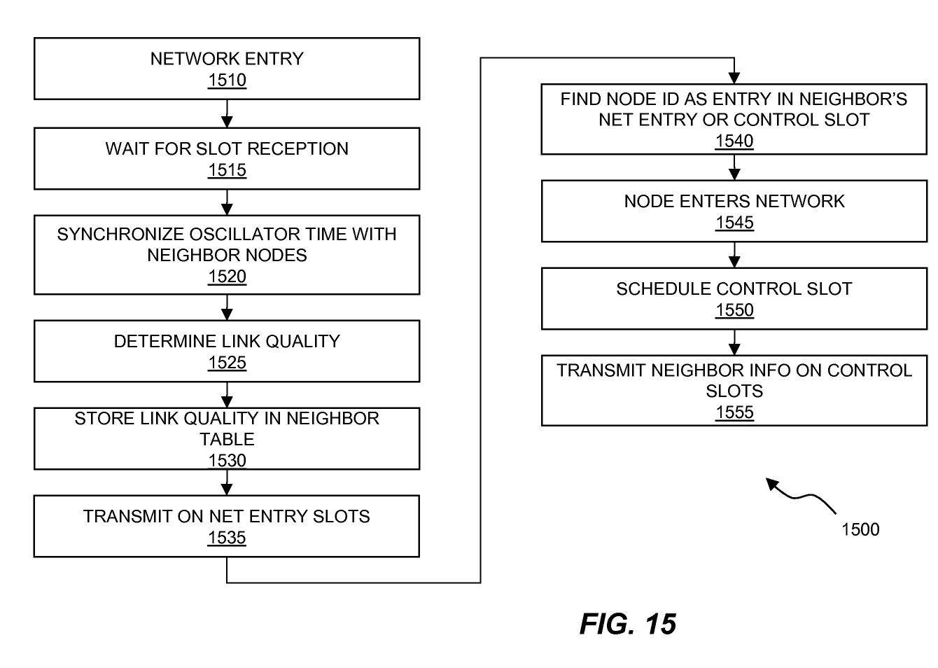

FIG. 15 is a flowchart of a method entering a network with a non-GPS node. Nodes may exchange information on power up or on movement into a new neighborhood. By exchanging information, nodes may identify one another and thereby facilitate formation and update of wireless networks as needed.

As shown in step 1510, a node may enter a network, such as when the node powers up or moves into a location within the network (which may, for example, be a BAP domain, a neighborhood, or any other suitable zone for management of nodes within a MANET).

As shown in step 1515, the node may wait for slot reception. When a node does not have capability to receive information from global positioning system (GPS) satellites, timing may be obtained from the surrounding neighborhood. A node may need to receive TDMA information and wait for a time slot in order to detect the presence of a network.

As shown in step 1520, the process may include synchronizing timing between a node and one or more neighbor nodes in a neighborhood of a wireless ad hoc network. An oscillator from the node may synchronize with other timing oscillators in neighboring nodes. Once these oscillators are synchronized then the node and its neighbors may operate and communicate in a TDMA environment. Synchronizing timing may include exchanging timing information between the node and the one or more neighbor nodes to synchronize timing oscillators. Synchronizing timing may include obtaining timing from outside the wireless ad hoc network and may include obtaining timing from one or more global positioning system (GPS) satellites.

As shown in step 1525, the process may include determining a link quality between the node and at least one of the one or more neighbor nodes. Based on communication across the TDMA slots, link quality between the various nodes may be determined.

As shown in step 1530, the process may include storing the link quality in a neighbor table for the node. The link quality which was determined may be stored in the neighbor table for the node.

The process may include identifying time slots for communication by the node wherein the time slots include control slots and data slots, the control slots further including network entry slots that are randomly accessible on a contention basis and scheduled control slots for which access is scheduled on a predetermined basis within the neighborhood. As shown in step 1535, transmission may occur on the network entry slots. During this transmission a node may announce itself to the surrounding nodes. The transmission may include node identity and the link quality. The surrounding nodes may then in turn store information on the node in their own neighbor tables. The process may include sending network entry information to the one or more neighbor nodes using one of the network entry slots, the network entry information including a node identity for the node and the link quality.

As shown in step 1540 the node may detect its node id being transmitted from a neighbor's node on network entry or control slots. This confirms for the node that it has entered the network. Where the initial entry fails, or a collision is detected in the network entry slot at the time of the network entry transmission, the node may backoff a random amount (such as with a random backoff counter) and retransmit on the next available network entry slot. The process may include detecting a collision when sending network entry information. The process may further include counting down a random backoff counter before retransmitting the network entry information in one of the network entry slots. Furthermore, the process may include setting the random backoff counter based on a number of nodes within the neighborhood.

As shown in step 1545, the node may enter the network. Entry to the network may be accomplished when entries in the neighbor tables for the node and its neighbors indicate links between the nodes. There may be a threshold or other requirement for link quality before a node is admitted to the network.

As shown in step 1550, a control slot may be scheduled. This may include any suitable techniques for allocating time slots to nodes within an ad hoc network. When the scheduled time slot is allocated to the node, the node may access the time slot and transmit control data.

As shown in step 1555, the process may include transmitting neighbor information using one of the scheduled control slots allocated to the node, the neighbor information including data for updating a neighbor table at one or more of the neighbor nodes. Neighbor info may be transmitted on the scheduled control slot. This neighbor info may then be used by one or more neighbor nodes that receive the transmission to update their neighbor tables. By contrast, where the scheduled control slot is allocated to another node, the node may receive data on the scheduled control slot and use this data to update the node's neighbor table. The process may include dynamically converting one of the data slots into one of the scheduled control slots. The process may further include dynamically converting one of the data slots into one of the scheduled control slots when a threshold is exceeded for a number of time slots which have passed since the node has transmitted on one of the scheduled control slots. The process may include dynamically converting one of the scheduled control slots into one of the data slots.

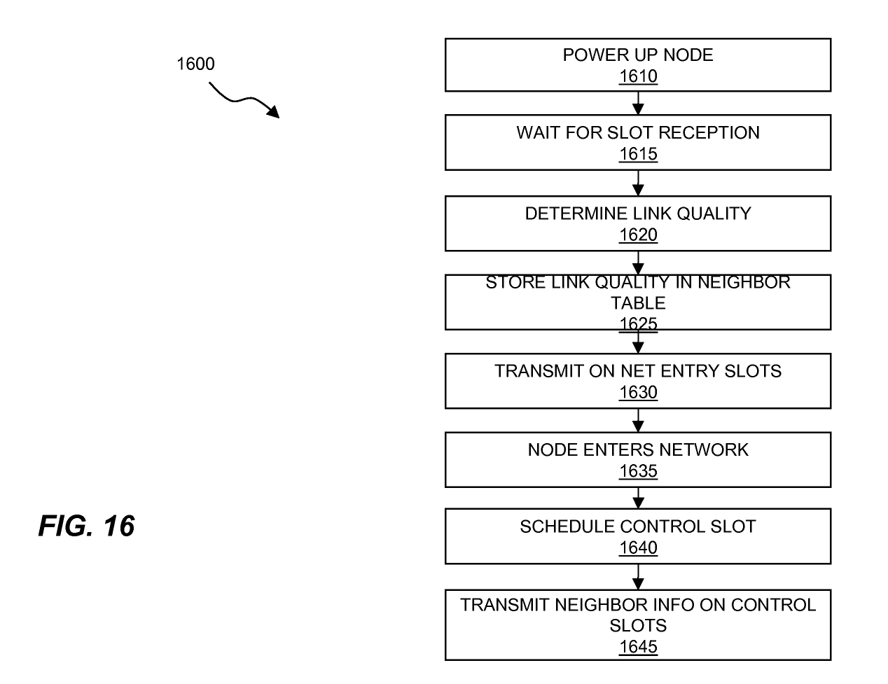

FIG. 16 is a flowchart of a process for entering a network with a GPS-enabled node. Fewer steps may be required for GPS enabled nodes as timing or synchronization may be obtained directly through the GPS.

As shown in step 1610, a node may enter a network when it powers up or otherwise moves into the physical footprint of the network.

As shown in step 1615, the node may wait for slot reception. When a node has capability to receive information from global positioning system (GPS) satellites, timing may be obtained from the GPS. A node may need to receive TDMA information and wait for a time slot in order to detect the presence of a network.

As shown in step 1620, link quality may be determined. Based on communication across the TDMA slots, link quality between the various nodes may be determined.

As shown in step 1625, the link quality which was determined in step 1620 may be stored in the neighbor table for the node.

As shown in step 1630, transmission may occur on the network entry slots. During this transmission a node may announce itself to the surrounding nodes. The surrounding nodes may then in turn store information on the node in their own neighbor tables.

As shown in step 1635, the node may enter the network. Entry to the network may be accomplished when entries in the neighbor tables for the node and its neighbors indicate links between the nodes. There may be a threshold or other requirement for link quality before a node is admitted into the network. Entry may also simply be accomplished by detecting a reception slot and announcing the node on network entry slots. The node may detect its node id being transmitted from a neighbor's node on network entry or control slots or it may otherwise infer participation based upon other control data from other nodes.

As shown in step 1640, a control slot may be scheduled. This may include any suitable techniques for allocating time slots to nodes within an ad hoc network. When the scheduled time slot is allocated to the node, the node may access the time slot and transmit control data.

As shown in step 1645, neighbor info may be transmitted on the scheduled control slot. This neighbor info may then be used by receiving nodes to update their respective neighbor tables.

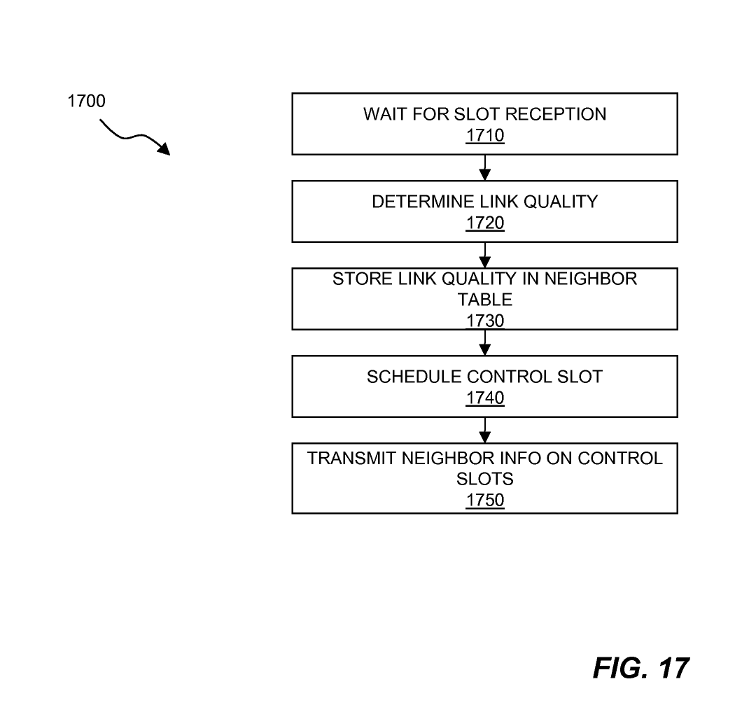

FIG. 17 is a flowchart of a method 1700 for updating information for a node that is already in a network. As shown in step 1710, the node may wait for a reception slot. Alternatively, the TDMA slots may already be allocated and this step may be omitted.

As shown in step 1720, the node may determine link quality between the node and some other node in the neighborhood.

As shown in step 1730, the link quality which was detected may be stored in the neighbor table.

As shown in step 1740, a control slot may be scheduled.

As shown in step 1750, neighbor info may be transmitted on the scheduled control slot. More generally the node and its neighbours may exchange neighbor information to be used in routing calculations, access control and the like using any suitable protocol(s) or algorithm(s) consistent with organized access to the TDMA time slots.

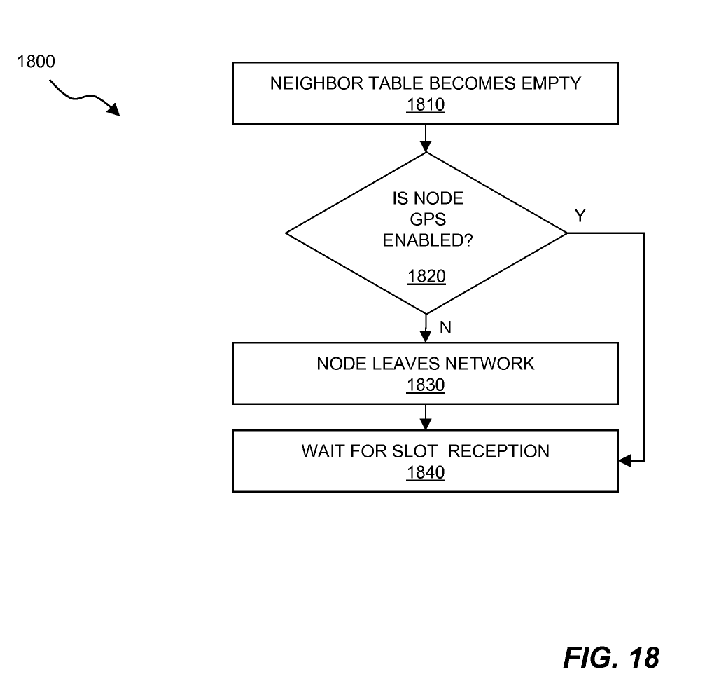

FIG. 18 is a flowchart of a method for a node leaving a network. Over time, various events such as link quality reduction or explicit removal of a node identifier from a neighbor's neighbor table may lead to a reduction of entries in a node's neighbor table. At some point, the neighbor table for a node may become empty, as shown in step 1810. If the node is GPS enabled, as shown in step 1820, flow may branch to step 1840. If the node is GPS enabled then the node may continue to look to detect nearby neighbours, which may continue indefinitely or for some predetermined period after which, for example, the node may turn off or take other action. As shown in step 1840, the node may continue to wait for a reception slot.

As shown in step 1820, if the node is not GPS enabled, flow branches to step 1830. As shown in step 1830, the node may then leave the network. Once the node leaves the network, as shown in step 1840, the node may wait for a reception slot to detect a network to enter or take any other suitable action.

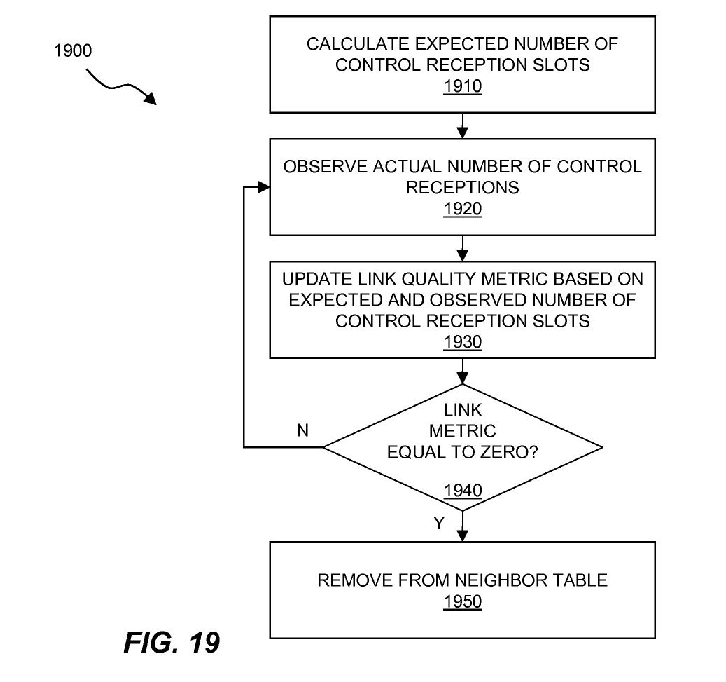

FIG. 19 is a flowchart of a method for updating link quality. In a TDMA environment slots may be anticipated on a regular basis and based on actual detection versus expected detection, link quality may be determined. As shown in step 1910, an expected number of control reception slots may be calculated. As shown in step 1920, an actual number of control slot receptions may be observed. As shown in step 1930, an update link quality metric may be calculated based on the expected and observed number of control reception slots. If the link metric reaches zero, as shown in step 1940, flow branches to step 1950. As shown in step 1950, the entry may be removed from the neighbor table because the link metric has reached zero.

If the link metric is not zero, as shown in step 1940, flow branches to step 1920. In step 1920 the observation of the number of actual control receptions may be repeated and flow may continue to possibly update the link quality metric.

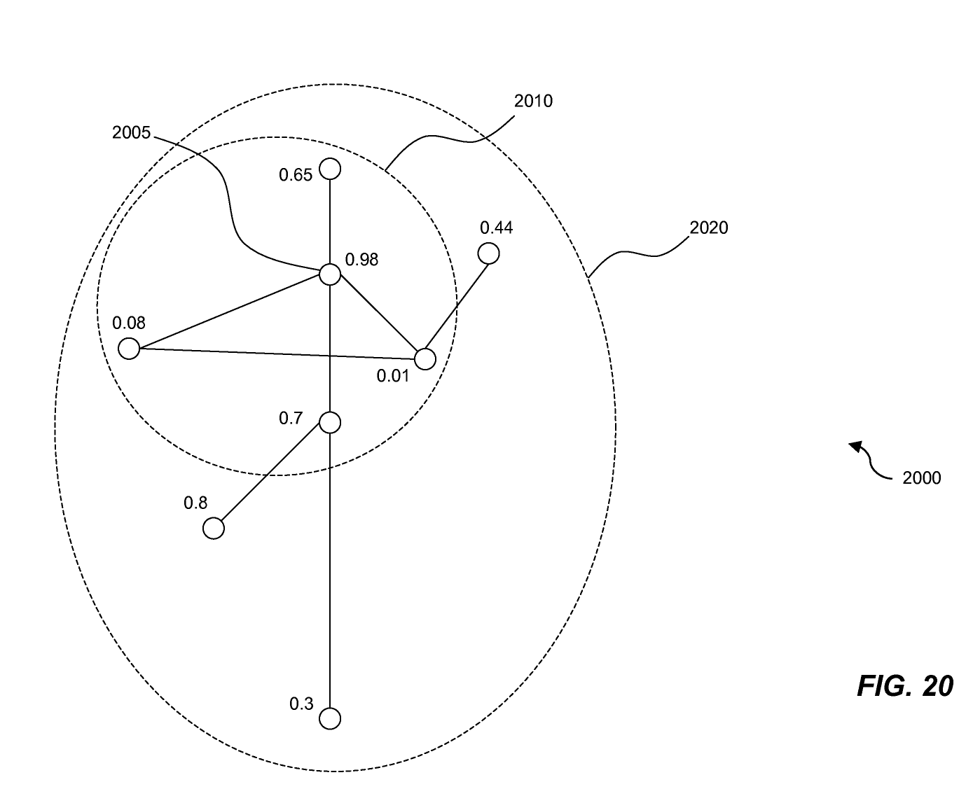

FIG. 20 shows a MANET 2000 with a one hop neighborhood 2010 and a two hop neighborhood 2020 for a node 2005. Channel Access protocols may be used to determine which nodes in a neighborhood may transmit in which time slots, given a TDMA environment. Two common classes of channel access algorithms are contention-based and scheduled. Multimedia Internet data can have widely varying characteristics and delivery requirements including data rate, latency, and jitter requirements. In order to provide a sufficient level of Quality of Service (QoS), priority channel access may be given to some nodes to allow them to meet QoS requirements for their data. Contention-based schedulers have difficulty providing prioritized channel access since nodes don't typically know when a nearby node has high priority data to send, requiring prioritized channel access. Within the class of scheduled channel access algorithms, a centralized node may compute the channel access schedule and distribute the schedule to all affected nodes.

Alternatively, a distributed channel access schedule may be computed locally by all individual nodes using a common set of scheduling metadata that is distributed among the nodes. A Node Activated Multiple Access (NAMA) scheduler is an example of a distributed scheduler for channel access in MANETs. Each node may compute a channel access “score” for every node in its two-hop neighborhood. An example of a MANET topology and two-hop neighborhood 2020 is shown in FIG. 20 along with example calculated node scores for a single time slot where no prioritized access is given. The scores may reflect, among other things, a level of data congestion at each one of the nodes. The node scores may reflect other characteristics of the nodes or the data which is currently at the nodes including priority, link quality, signal strength, dropped packets, or any other useful metrics for measuring either or both of the data transmission needs of the node and the data links available for transmission from the node.

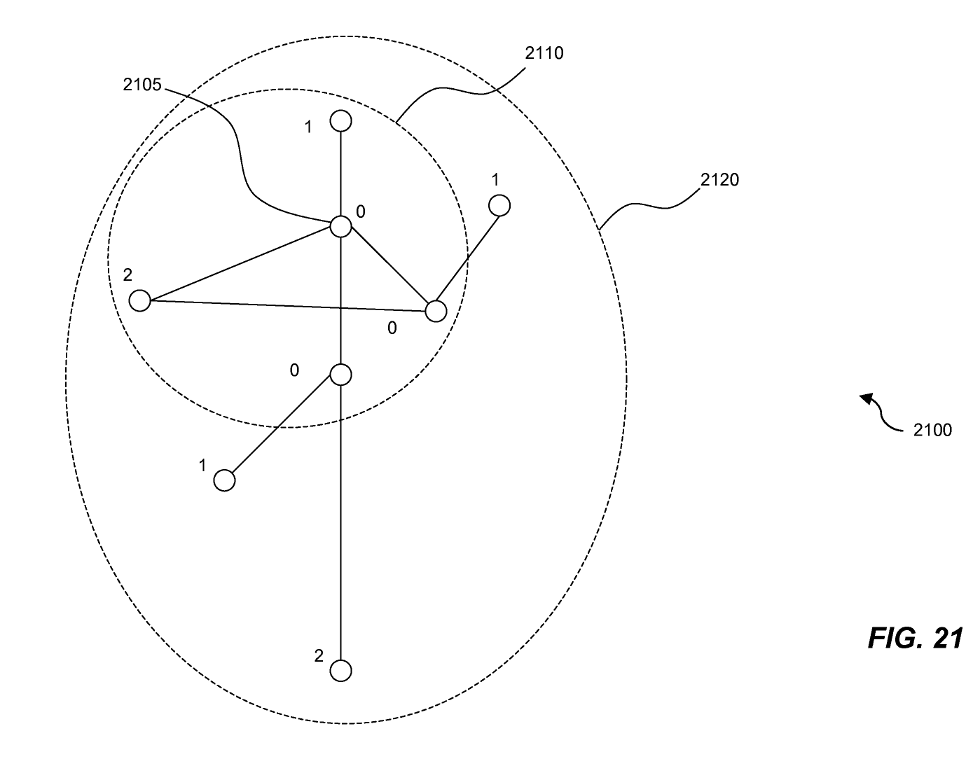

FIG. 21 shows node weights that may be employed to adjust node scores to achieve QoS requirements. As part of the NAMA scheduling metadata, a node weight parameter may be used for each node to indicate when the node needs greater channel access, such as to meet QoS requirements for data at that node. In general, the nodes with a weight of zero will be fully de-weighted in a scheduling algorithm and will not be allocated any time slots for channel access. Nodes with a weight of one will receive a score equal to the score without weighting. Nodes with a weight of two will have their scores doubled when submitting node scores to the scheduling algorithm. It will be appreciated that while integer values are depicted in FIG. 21, any suitable weights may be employed (consistent with the related scheduling algorithm) to bias time slot allocation toward nodes with greater QoS requirements.

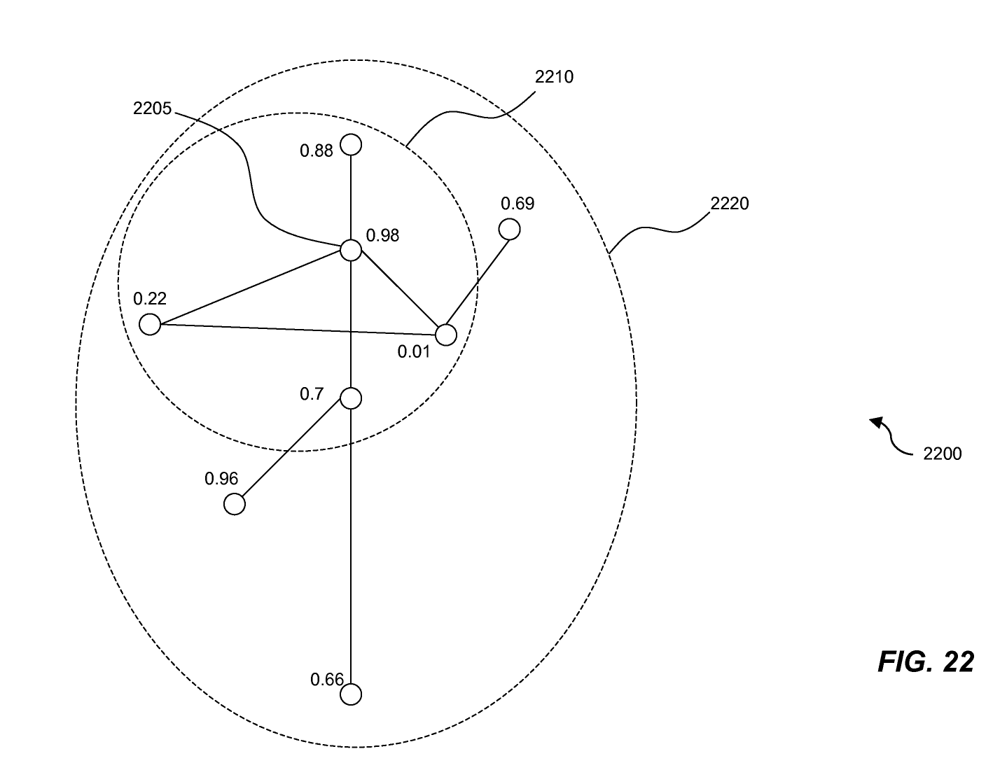

FIG. 22 shows another technique for meeting QoS or other requirements for data delivery. In this method, weights for node scores may be skewed according to any suitable function such as a hash function to bias time slot access. Thus for example, while several nodes have the same scores after skewing as the pre-skewed nodes depicted in FIG. 20, other nodes have increased scores resulting from the skewing. As with explicit node weighting, this may serve to bias time slot allocation toward one or more nodes with greater QoS requirements. While the skewing may improve the statistical likelihood that nodes with higher node weights will acquire channel access, this can also be used in combination with specific node weightings as depicted in FIG. 21 in a manner that still provides an opportunity for nodes fully de-weighted to zero to participate in contention for time slots. That is, the specific node weights may be applied bringing a node weight to zero, and the nodes may be subsequently skewed in a manner that raises the zero-weight node to some positive value. It will be appreciated that while certain values such as zero (for full de-weighting) and one (for neutral weighting) are described, any suitable values or range of values may be employed to similar effect without departing from the scope of this disclosure.

In another aspect, a contention domain may be established that limits the nodes in the two-hop neighborhood that are submitted to a scheduling algorithm. This technique may employ any suitable threshold, metric, or other definition to pre-select the subset of nodes in (or exclude a subset of nodes from) the contention domain. Possible thresholds for pre-selection include but are not limited to node weights equal to a specific level, node weights greater than or equal to a specific level, node weights less than a specific level, device type (e.g., access point, subscriber device, etc.), service level agreement, and so forth.

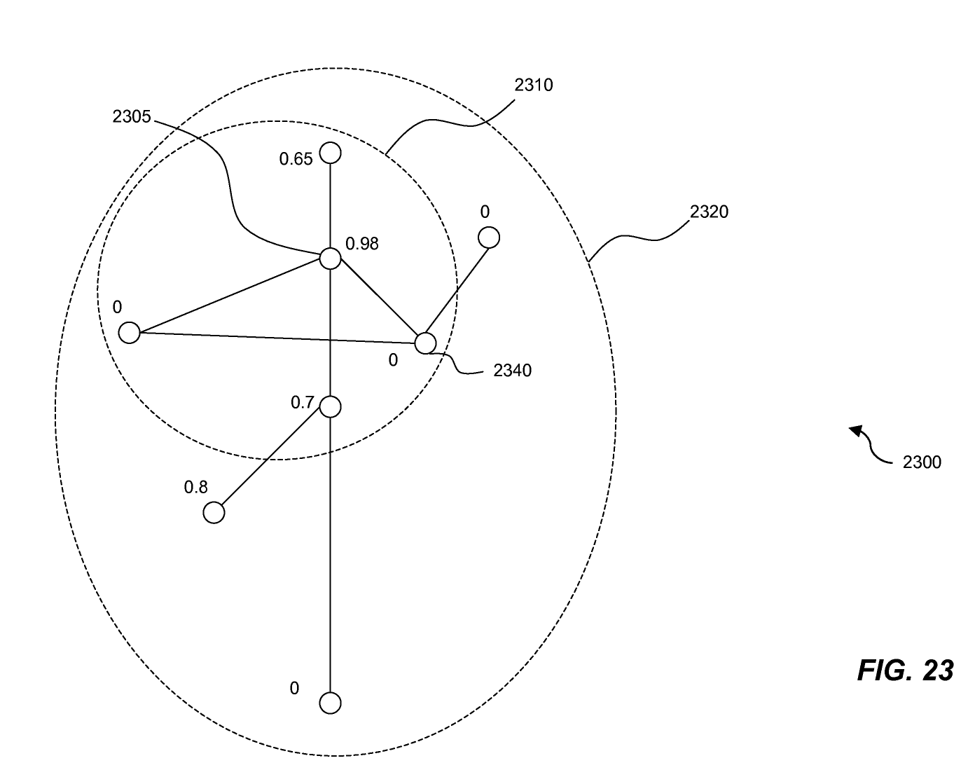

FIG. 23 shows an example of the node scores where a contention domain has been established for the nodes of FIG. 20 that is restricted to all nodes with node weights greater than or equal to 0.5. It will be appreciated that the numeric values are arbitrary, and that any suitable values or range of values may be employed to similar effect. All nodes outside the contention domain may have their node scores modified and set to zero for purposes of scheduling. As a result, node 2305 (with a node score of 0.98) may be included in the contention domain while node 2340 (with a node score of 0.44) may be excluded from the contention domain. It will be appreciated that a similar affect may be achieved by using node weights of one or zero to denote inclusion or exclusion, although there may be practical differences. For example, in a contention domain, the node scores may be calculated and the processed with one or more rules to identify the contention domain, whereas in the weighting approach described above, the weights may be determined without any a priori information about the particular node scores. The contention domain may be used to ensure that (or improve the chances that) a node requiring prioritized channel access is granted channel access for a time slot within a TDMA epoch. If there are no nodes eligible to participate in the contention domain, the contention domain may be expanded to include all nodes in the two-hop neighborhood. A benefit that may result from this approach is reduced computational complexity that results from reducing the number of nodes that need to be processed by the scheduling algorithm.

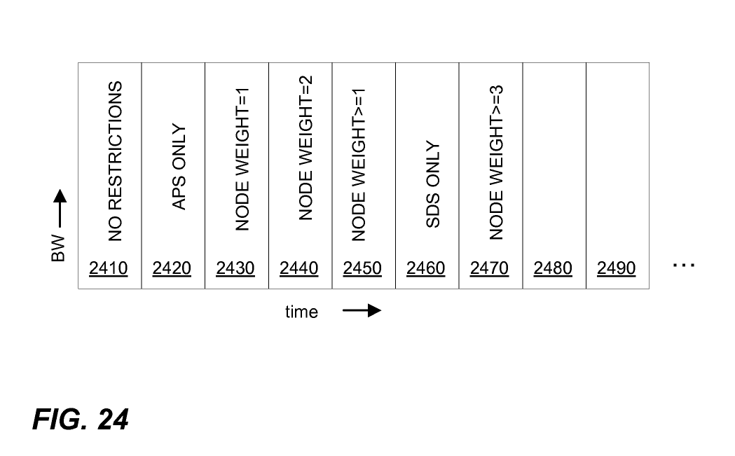

Another technique for refining the use of contention domains is to associate a defined contention domain rule for each time slot in a repeating frame structure. An example is shown in FIG. 24. Time slots 2410, 2420, 2430, and so on are shown. Certain time slots may be dedicated to specific uses. For example time slot 2420 is available only for use by access points. Time slot 2430 is available only for nodes with weights of one. Time slot 2470 is available only for nodes with weights greater than or equal to three. Other similar restrictions may be provided for various time slots in the TDMA environment.

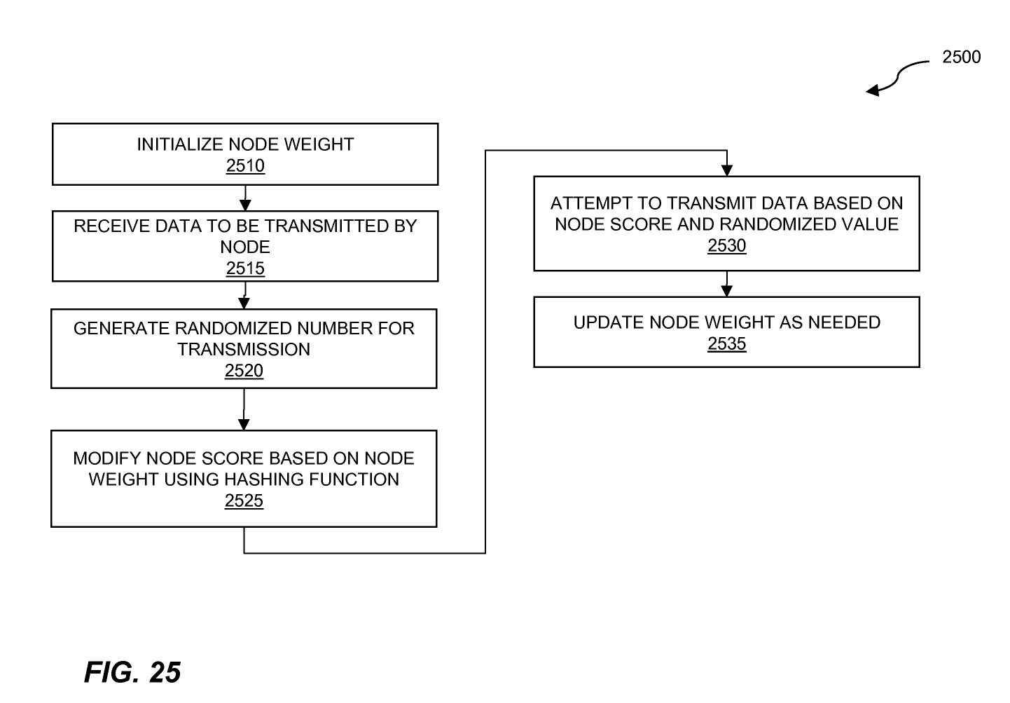

FIG. 25 is a flowchart of a method 2500 for weighted transmission. As shown in step 2510, a node weight may be initialized. All nodes may start with the same value when entering a network or on power up. Alternatively a node may receive higher weight based on a characteristic of the node such as a node being an access point. Certain nodes may be known to have higher priority users or have users that have paid a fee for premium service and therefore start with a node weight which is higher. Other characteristics may affect the initial node weight that a node receives. Node weights may be integer in value and in some embodiments may range from zero to five. Each node may have a score that is a function of data congestion at the node (and any other suitable metrics or parameters). In some embodiments the node score may be decimal in value and range from zero to one with low numbers, such as 0.1, indicating smaller amounts of data congestion, and larger values, such as 0.95, indicating significant data congestion at a node. A node score may be modified based on node weight when scheduling channel access for the node.

As shown in step 2515, data may be received by the node for transmission. This may include data that arrives at the node from another node in the network, or data internally generated by a data source within the node. As more data arrives at the node, or as the transmit queue(s) for the node grow with a backlog of untransmitted data, the node score may be modified to indicate larger congestion at the node. In another aspect, congestion may be proactively predicted by obtaining a measure of the queue of outbound data for the node at one or more other neighboring nodes.

As shown in step 2520, a random number may be generated at the node. A new random number may be generated for each new time slot or a random number may be retained through a longer period of operation of the node. The random number may be used so that nodes with the same node weight or node score can arbitrate to determine which node should transmit first. In some embodiments no randomization may occur and this step may be omitted. In some embodiments a combination of the node score, the node weight, and the random number may be used to decide which node may transmit in a given time slot.

As shown in step 2525, the node score may be modified based on the current node weight. The node score may also or instead be modified using a hashing function to skew weighting across nodes as described above.

As shown in step 2530, the node my attempt to transmit on the wireless network based on the modified node score. The random number may be used in any suitable manner to arbitrate between the nodes and help select which one should transmit, such as in a weighted fair coin flip or the like to select time slots for each node.

As shown in step 2535, the node weight may updated according to changes in node and network conditions at any suitable interval, and the process 2500 may return to step 2515 where new data may be received for transmission by the node.

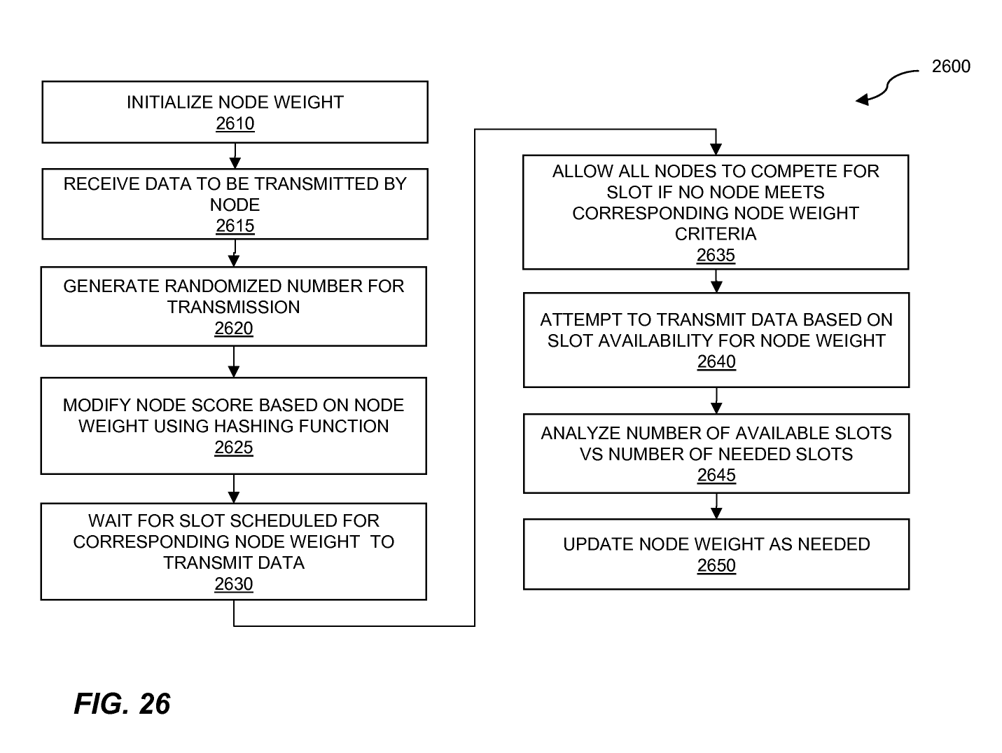

FIG. 26 is a flowchart of a process 2600 for transmission based on weights. Even when weights are used to modify node scores, nodes with low weights may periodically win the competition to transmit on a given time slot. An alternative is described which allows specific weights to transmit on specific time slots.

As shown in step 2610, a node weight may be initialized for a node. As shown in step 2615, data may be received or generated at a node for transmission. As shown in step 2620, the process may include generating a random number for each one of the plurality of nodes in the neighborhood having a specific node weight and further restricting access to the time slot based on the random number. A random number may be generated to assist in selection of a node for transmission. As shown in step 2625, a hashing function may be used to modify a node score based on a node weight. These steps may be similar to those described earlier. The process may include identifying a plurality of nodes in a neighborhood including the node and one or more neighbor nodes. The neighborhood may include a two hop neighborhood for the node. The process may involve calculating a node score indicative of traffic congestion for the node and a node weight indicative of access requirements for the node. It may further involve receiving a neighbor node score indicative of traffic congestion from each of the one or more neighbor nodes and a neighbor node weight indicative of access requirements from each of the one or more neighbor nodes.

As shown in step 2630, the node may wait for a time slot dedicated to the current node weight for the node. The process may include identifying a time slot for communication within the neighborhood. TDMA time slots may be allocated for specific node weights. Time slots may also be allocated for a collection or range of node weights, such as a certain time slot for all node weight values of one or more. The node may wait for an appropriate time slot.

As shown in step 2635, if no nodes in the neighborhood meet a certain criteria for a given time slot, all nodes or a different subset of nodes may be allowed to compete for that time slot. For example, if a time slot is dedicated for node weights of 4 but there are no nodes with a weight of 4, rather than not using that time slot and leaving it empty, all nodes in the neighborhood may be allowed to compete for transmission. The process may include restricting access to the time slot by the node when the node weight for the node does not meet a node weight requirement. It may also include restricting access to the time slot by each one of the neighbor nodes that has a neighbor node weight that does not meet the node weight requirement. Restricting access may include withholding the node from participation in the scheduling algorithm for access to the time slot. The node weight requirement may include a minimum threshold for the node weight or a maximum threshold for the node weight. The node weight requirement may include an inclusive threshold for the node weight or an exclusive threshold for the node weight.

As shown in step 2640, the node may attempt to transmit data on the corresponding slot for its given node weight once the time slot arrives. If multiple nodes meet the criteria for the time slot, the random number which was generated may be used to arbitrate between them to determine which should transmit on the time slot. The process may include applying a scheduling algorithm based on the node score and the node weight to determine whether the node can access the time slot when the node has a node weight that meets the node weight requirement. It may further include transmitting data from the node in the time slot when the node is scheduled for access to the time slot. The scheduling algorithm may be based on the neighbor node weight for one or more of the neighbor nodes and the neighbor node score for one or more of the neighbor nodes. The scheduling algorithm may be based upon neighbor data exchanged among the plurality of nodes in the neighborhood and stored in a neighbor table of the node.

As shown in step 2645, the number of available time slots versus the number of needed time slots may be evaluated. There may be more data for certain time slots for a given weight than time slots available. As shown in step 2650, the node weight for the node may be updated based on the time slot availability. Further, the node weight may be calculated based on one or more of a power level, a geographic location, a mobility, a node type, and a frequency of operation.

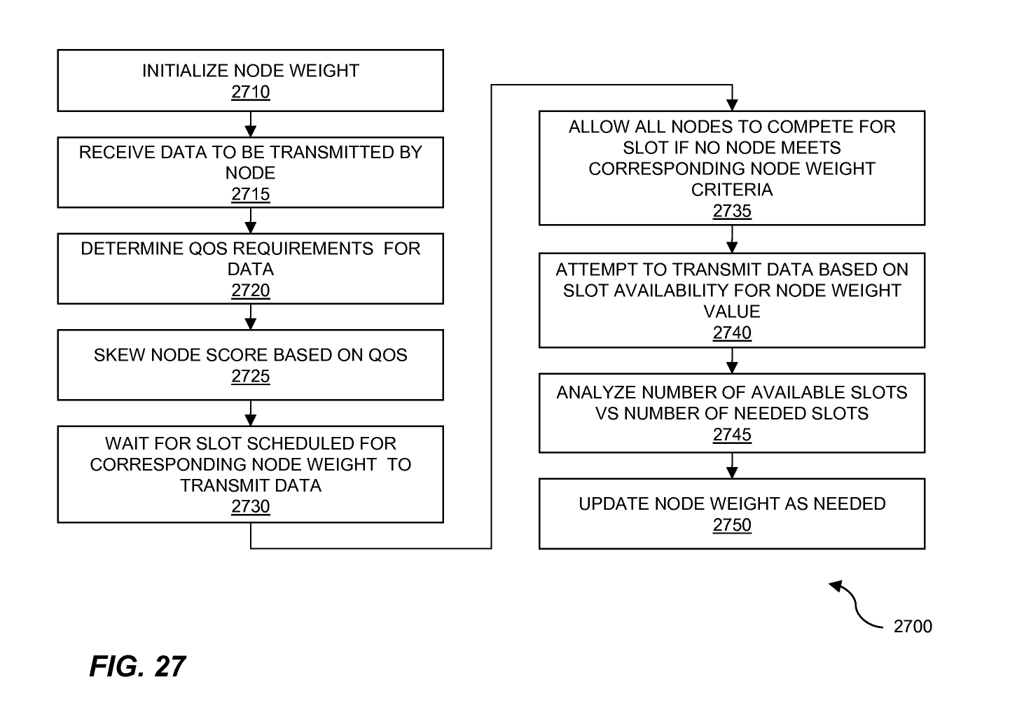

FIG. 27 is a flowchart of a process for transmission based on Quality of Service (“QoS”) requirements. Techniques are described which allow higher QoS data to be sent before lower QoS data. The process may include identifying a plurality of nodes in a neighborhood including the node and one or more neighbor nodes. It may further include calculating a node score indicative of traffic congestion for the node and a node weight indicative of access requirements for the node. The neighborhood may include a two hop neighborhood for the node.

As shown in step 2710, a node weight may be initialized for a node. As shown in step 2715, data may be received or generated at a node for transmission. These steps may be similar to those described earlier. The process may include receiving a neighbor node score indicative of traffic congestion from each of the one or more neighbor nodes and a neighbor node weight indicative of access requirements from each of the one or more neighbor nodes.

As shown in step 2720, the process may include determining a quality of service (QoS) requirement for data to be transmitted from the node. QoS requirements for the received data may be determined. The QoS requirements may depend upon the traffic type of the data itself or may be determined based on the source or destination of the data or any other suitable metric. The QoS requirement for data to be transmitted from the node may include one of a plurality of QoS levels for the data. Determining the QoS requirement for data may include inspecting a header of the data for QoS information. Determining the QoS requirement for data may include determining a traffic type of the data.

As shown in step 2725, the process may include skewing the node weight for the node and the neighbor node weight for each neighbor node based on the QoS requirement to provide a QoS node weight for each node in the neighborhood. The node score may be skewed based on the QoS requirements. Skewing may include using a hash function. Higher QoS requirements will skew node scores higher. The skewing may be accomplished with a hashing function. Node weights may also or instead be skewed based on the QoS. Higher QoS would be reflected with a higher node weighting. In some embodiments the higher node weighting may only be reached with high QoS requirements. For example, a node weighting of four or five may be restricted to use only with high QoS data. Skewing may include prioritizing the data based on the QoS requirement. Skewing may include skewing according to the QoS requirement for traffic at each node in the neighborhood.

As shown in step 2730, the process may include identifying a time slot for communication within the neighborhood. The node may wait for a time slot dedicated to the node weight (or weighted node score) for the node as described above. The time slots may for example be divided into different levels for the purposes of scheduling so that only nodes with node weights or scores meeting the time slot requirement (e.g., below a value, above a value, or within a range of values) participate in the scheduling algorithm applied to that time slot. This approach may be biased to provide opportunities for nodes with higher node weights or scores to win more slots per second in order to meet their need for increased channel access. The process may include applying a scheduling algorithm based on the node score and the QoS node weight for the node to determine whether the node can access the time slot when the node meets the node weight requirement. The scheduling algorithm may be based upon neighbor data exchanged among the plurality of nodes in the neighborhood and stored in a neighbor table of the node.

As shown in step 2735, the process may include restricting access to the time slot by the node when the QoS node weight for the node does not meet a node weight requirement. If no nodes in the neighborhood meet a certain criteria for a given time slot, all nodes or a different subset of nodes may be allowed to compete for that time slot. For example, if a time slot is dedicated for node weights of 4 but there are no nodes with a weight of 4, rather than not using that time slot and leaving it empty, all nodes in the neighborhood may be allowed to compete for transmission. Restricting access may include withholding the node from participation in the scheduling algorithm for access to the time slot.

As shown in step 2740, the process may include transmitting data from the node in the time slot when the node is scheduled for access to the time slot. The node may attempt to transmit data on the corresponding slot for its given node weight once the time slot arrives. If multiple nodes meet the criteria for the time slot, the random number which was generated may be used to arbitrate between them to determine which should transmit on the time slot.

As shown in step 2745, the number of available time slots versus the number of needed time slots may be evaluated. There may be more data for certain time slots for a given weight than time slots available. As shown in step 2750, the node weight for the node may be updated based on the time slot availability.

Additionally, in a MANET nested weighted round robin queues may be employed to selectively provide channel access for traffic according to a priority or Quality of Service (QoS) for data. By nesting queues within other queues, and by applying a weighted round robin technique to serve each queue, relatively arbitrary service metrics may be achieved including nodal QoS for class-based traffic, avoidance of queue starvation, and so forth. Prioritized queues may also be provided for preemptive delivery of high priority traffic. Various qualities of service may be provided by allocating channel usage between nodes and among classes of traffic. This may be achieved through combined data queuing, which influences which traffic is allowed on the channel, and channel access, which influences which channel may be used and when.

The capacity of a MANET 100 may be improved or maximized using neighborhood selection algorithms and link coloring as described below. In general, these techniques aim to reduce a power level across the MANET 100 by accounting for communication requirements within (and without) a selected neighborhood. The general approach may be varied depending upon the size and dynamic nature of the MANET 100, such as by adapting the size of the tree and the frequency with which the tree is updated in order to remain within the computational capabilities (and network overhead limitations) of a typical node within the MANET 100. In addition, it will be understood that graph theory provides a variety of techniques, any one or more of which may be the preferred technique within a particular context.

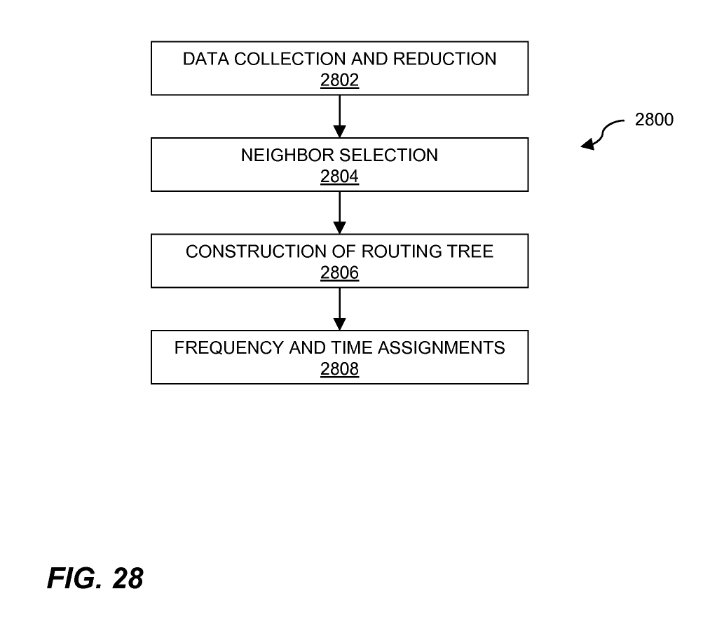

FIG. 28 shows a process 2800 for increasing capacity in a MANET. A useful algorithm may be deployed with 5 basic phases in the scheduling—an approach which may yield suboptimum results, but can reduce computational complexity for environments with limited computational resources. The process may include discovering one or more neighbor nodes to a node in the wireless ad hoc network wherein the one or more neighbor nodes are within a one-hop neighborhood. It may further include creating a neighbor table for the one or more neighbor nodes. As shown in step 2802, a first step may include data collection and initial data reduction. Data to drive the subsequent algorithms is collected and extraneous data is pruned to reduce the computation in later phases. As shown in step 2804, a second step may include neighbor selection such as determining candidate node links that are available as links in the routing algorithm. As shown in step 2806, a third step may include construction of a routing tree with access points (such as backhaul access points) at the root and route distances on each hop that enables all leaf nodes to be reached. As shown in step 2808, a fourth step may include frequency and time assignments to maximize the traffic supportable on the trees taking into account interference zones and the like that might prevent simultaneous communications between other nodes in the tree.

For purposes of the following description, it is assumed that each node has a list of neighbors that are reachable using maximum power during a neighbor discovery process and all one hop neighbors are known from this discovery process; however, this assumption may be relaxed with suitable adaptations to the remaining processing steps.

As shown in step 2802, the process may include collecting data from the one or more neighbor nodes wherein the data comprises inter-node link loss and Euclidean link distance. This phase may include data collection and reduction. A neighbor table may be created from all of the reachable one hop neighbors using a high power/low modulation order waveform with link costs in terms of the link loss and range data from the metadata provided by the physical layer. A node may receive and collect information from the one hop neighbors that include their one hop neighbors that are in common with the local node one hop neighbors. This may include information such as inter node link loss and range. Given the common data base used, all nodes may select the same neighbors using local algorithms. The process may include the selecting neighbors to limit the number of links further comprises assembling a Delaunay tessellation based on one of a group comprising the link loss and the Euclidean link distance. Selecting neighbors to limit the number of links may further comprise performing cost route analysis from each of the common set of nodes and performing graph analysis of resulting routes from the route analysis. The route analysis may be based on a minimum transmit energy.

In one MANET embodiment, the physical layer may report the metadata for all receptions such as the transmitted power and modulation mode, RSSI, SNR and link delay with approximately 1 dB and 200 ns resolution in the normal mode. A higher resolution mode may exist, but may rely on special scheduling cells to enable the higher resolution mode. From the metadata a one hop neighbor table may be generated and maintained. This table may include the one hop neighbors and the common neighbor information so that all nodes linked in a triangle are known for the next phase. The neighbor table may be advantageously arranged for easy access to these neighbor triples (three node IDs and the distance metrics between the nodes).

As shown in step 2804, the process may include identifying a common set of nodes from the node and the one or more neighbor nodes where each of the common set of nodes are one-hop neighbors of each other node in the common set of nodes. This phase may include neighbor selection. The process may include reducing the data which was collected in the neighbor table so that a reduced neighbor table includes only information on the common set of nodes. The process may also include selecting neighbors to limit a number of links between the common set of nodes. This phase may be used to limit the number of links between nodes for consideration in the routing phase of the algorithm as a preprocessing step to reduce the search space both in the routing and in the scheduling phase. This may include, for example, constructing a Delaunay tessellation of the mesh using either link attenuation data or Euclidean distances from the reachable neighbor tables for the local node. From this tessellation, the neighbor tables may be pruned to include only the Delaunay neighbors. This will also yield the same/consistent neighbors as the other nodes using the common data. Alternately the shortest routes using Dijkstra or similar algorithm may be used to find the lowest-cost routes from each node and the graph of the resulting routes may be generated. Cost may be determined, e.g., using minimum transmit energy as the link cost metrics (in linear scale) to provide the lowest possible total energy to relay messages to an access point. This approach is also equivalent to minimizing the interference area, leading to more potential simultaneous transmissions. All route constructions thus far restrict each node to have a single parent which leads to more efficient scheduling to follow. Other algorithms other than Dijkstra may similarly be employed, although the selection of a specific algorithm may depend upon the efficiency and ease of distributing across a MANET network.

A number of neighbor selection methods are known in the art, and may be suitably employed. In one aspect, a number of different methods may be employed and performance compared in order to determine a preferred method for a particular environment.

In one technique, triples in the neighbor table may be used to form the Delaunay tessellation surrounding the current node. The nodes that do not contribute to the tessellation can be eliminated quickly using algorithms to determine that a new inserted node lies outside the current Vonoroi neighborhood. In typical situations the vast majority of the candidate insertion node lies outside the neighborhood and if used to advantage, may yield an efficient algorithm for this construction. Most methods require O(log n) operations to complete the tessellation. From tessellation, a new neighbor table may be created that only includes the Delaunay neighbors. From this pruned one hop neighbor table the routes may be computed in the next phase. In the tessellation the following algorithm can be used, although other algorithms are known, and may operate more efficiently under certain conditions.
1) Assign the current node n₀ to location (x₀ y₀)=(0,0)
2) From the current node n₀ find the nearest neighbor n₁ and its distance d₀₁. Create position n₁=(d₀₁, 0).
3) Find the next nearest neighbor n2 and its distance from the current node d₀₂ and distance between nodes 1 and 2 d₁₂. Triangulate and assign position (x2 y2)
4) Find the next nearest node and the distance between nodes 0, 1, and 2 and triangulate its least squares position.
5) Repeat until all node have a candidate (x, y) position
6) Refine the position of nodes using a least squares iteration
7) Using standard Delaunay algorithm find the tessellation in O(n log n) steps
   This process can be easily distributed using local information available (all one hop neighbors) and the link delay already computed for other purposes.

In other embodiments another routing algorithm may be used to find the paths that consume the minimum energy required to either reach a node from an access point or an access point from a node. This approach may combine the routing and neighbor selection process. For example, The Dijkstra algorithm may be used with link metrics equal to the linear transmit power required to reach the receiver on the link given the path loss estimate. Other algorithms known in the art may be similarly employed, and may be more efficient for different mesh network topologies. For example, in certain permissible paths all nodes may have only one parent along the routes to the access point. Exploiting this property may significantly reduce the computation required.

As shown in step 2806, the process may include constructing routing trees with access point s at a root of each routing tree and including one or more nodes from the common set of nodes on routes through the neighbors which were selected. This phase may include routing tree generation. This routing phase may further reduce the number of links that need to be considered in the scheduling phase by selecting only the links from the previous phase required for routing to and from nodes and access points (such as backhaul access points). Peer to peer communications may be pruned from the list that do not directly provide routes between a leaf nodes and the access point. It is not expected that significant traffic will be locally contained. Rather, most traffic is expected to either emanate from or terminate at an access point. This assumption may not be appropriate in all circumstances, and other expected behavior types may result in other approaches to routing tree generation. The process may include determining a lowest-cost route from each of the common set of nodes through the routing trees.

A tree may be generated from each access point as a root to all of the neighbors restricting the links to be neighbors (Delaunay or lowest energy routes). This tree building may be subject to different route cost selections and some potential ad-hoc rules for restricting the tree construction. In the construction of the tree there may be, for example, only one parent for every node rooted with an access point. Such a tree may have to be updated when changes to the topology are detected, such as a new neighbor entering the Vonoroi neighborhood that affects the tessellation. Each node may be responsible for notifying its neighbors of a topology change that necessitates a re-computation of the routing tree. To enable a distributed routing protocol there are two conditions that may be considered: (a) insertion/deletion of a parent node, and (b) insertion/deletion of a daughter node. Some nodes may not be able to reach an access point. In this case the routes that allow all reachable nodes may be constructed so the P2P traffic can be supported across the reachable neighborhoods. These clusters may be treated differently.

In general, routing trees may be generated using route metrics to choose a route from all nodes back to an access point that is a least cost route based on link metrics constrained to only use Delaunay links. Several possible routing methods can be used to accomplish the goal. The output of the routing is a list of links with each entry a tuple of [transmit node, receive node]. In one embodiment, all links may be considered symmetric (link can send data in both directions).

One suitable algorithm counts hops from an access point. The access point is assigned a hop count of 0. Each node that has a link to the access point has a hop count of one and so on. The hop count of each node may be advertised. If a node does not have a hop count assigned, it may search the neighborhood tables and find the node(s) with the minimum hop count. The node then assigns its hop count to be that hop count+1 and chooses a parent route to the node with the minimum distance. This information is propagated using Datalink Control Message (“DCM”) neighbor advertisements until all nodes have a hop count. One useful modification under certain conditions is for the current node to also find siblings and if the nearest sibling has a sufficiently low link cost compared to the closest parent, have the current node adopt that sibling as a parent. In this case the hop count is 1 greater than the simpler above algorithm.

This routing algorithm is effective in that the routes are generally good and require no central or even distributed computation to select the parent nodes. In geometric tessellation an access point has 5-6 daughters on average, and each daughter have 2 daughters on average which leads to a low hop count to an access point with limited branching in the routing tree (on average). Some heuristics can be used to improve the tree characteristics to provide improved performance. In one embodiment, if the number of daughters exceeds a threshold then the list of daughters may be pruned. This approach may additionally require that some additional local information be conveyed to the daughters that were being dropped from the one hop tessellation list.

As shown in step 2808, the process may include assigning frequency and time slots to maximize traffic supportable on the routing trees. This phase may include frequency and time assignments.

This may begin with constraint generation. Two constraint matrices may be created for the links. The first constraint matrix may be independent of frequency assignment, and may use only rules a & b below. The second matrix may use all of the rules below (and may be used to generate the scheduling constraints for a link on a specific slot and frequency). The rules may be applied on a per frequency and slot basis:
a. Each link may require a transmit. All links that use this node as a receive are eliminated for future consideration on this frequency/slot
b. Each link may require a receive. All links that use this node as a transmit are eliminated
c. The interference from the transmit may disable other links from consideration based on required transmit power and the path loss. A list of these interfered receive nodes may be found and all links that use these receive nodes may be eliminated
d. Other transmit can interfere with the candidate receive. All links that use a transmit that can interfere with this receive may be eliminated
e. If the transmit node in the candidate link is already transmit on this freq on another link then this may be eliminated from consideration.
f. If the receive nodes in the candidate link are already being used on another link with the same freq, it may be eliminated.

In order to create frequency and slot assignments for actual communications, a constraint satisfaction matrix may be created using, e.g., path loss, Euclidean distance, or some other metric(s). Frequencies may be assigned using a distributed constraints satisfaction algorithm from the routing trees for a set of available frequencies. If all links can be ‘colored’ using any suitable graph coloring technique, free frequencies can be assigned to heavily loaded links (usually the parent link). This schedule may be used for all data slots until a topology change necessitates a re-calculation of the routing tree. If not all links can be ‘colored’, multiple slot schedules may be created. Using the result of the previous step, a new time slot may be created for a two slot schedule and frequencies may be assigned to links not assigned in the first slot. If the assignment fails, this splitting may be repeated recursively until all links are assigned. Any remaining frequencies available on the last division may be assigned to the higher traffic links. Using this algorithm the number of links is equal to the number of non access point nodes. This provides the minimum number of required links (least interference) while fanning out the data rapidly from the access point nodes to maximize the network capacity and keeping the maximum hop count low. The process may include communicating signals through the routing trees on the frequency and time slots which were assigned.

More generally, a variety of techniques may be employed for time and frequency assignments based upon the preparatory steps described above. In one embodiment, graph coloring techniques may be employed. In a graph coloring approach, a graph consists of nodes or vertices that are connected with edges/links. In the traditional graph coloring problem the goal is to color each vertex with a color so that no two connected vertices (via an edge/link) are the same color with the minimum number of colors. The number of minimum colors required to color a graph G is represented by χ(G). While the optimum solution to the coloring problem is NP hard (exponential in the number of nodes), the problem becomes tractable with a small graph size, and an optimum solution can be found with exhaustive searches and a few simple restrictions that prune equivalent colorings (simple color permutations and other equivalent transformations). Where the graphs are rooted trees (as in the case where all trees are rooted at access points), the exhaustive search can be extended in size. In the cases where the graph is too large to be colored optimally (based upon the computational capacity of a node), greedy algorithms may be employed to achieve nearly optimum solutions for rooted trees. Other techniques are known for further optimizing graph coloring problems and calculating solutions, many of which may be suitably adapted for use with the methods and systems described herein.

In another aspect, various steps of the process 2800 described above may be refined or modified to achieve more centralized or distributed determinations of frequency and time assignments. The degree of centralization (or decentralization) actually used in a particular deployment will depend upon a variety of factors such as the amount of overhead available for exchanging data among nodes, the number of nodes in a neighborhood, the rate of change in a neighborhood of nodes, the processing capabilities of individual nodes, and so forth.

Data collection is generally distributed in nature. Each node collects data from its neighborhood and is local to that node. No special treatment is required to distribute this step in the algorithm; however increased overhead communications may be required to centralize calculations based upon the resulting data. For constraints, there are a number of Distributed Constraint Satisfaction (“DCS”) algorithms available. However since the global optimization of frequency assignments is bounded by O(N̂2) and is simple to implement and global information would have to be distributed to the leaf nodes to accomplish global optimization, it is generally preferred that optimization be placed in the access point where computational resources are typically greater. In the graph coloring approach described above, each node is responsible for coloring its neighborhood in a coordinated fashion using data from other neighbors. Using this approach, feasible graph sizes and relatively simple computation may be maintained provided the neighborhood size is small, thus allowing the algorithm to scale.

The foregoing methods and system may be usefully employed to improve scheduling in Mobile Ad Hoc Networks. In practical deployments, the computation is reasonable and approaches optimal results, as determined with a test data set including 287 nodes and 23 access point nodes. The local processing is limited and grows slowly (O(log n), where n is the number of local neighbors) and the global scheduling is moderate (O(N), where N is total number of nodes in the tree). The communications is O(N̂2) but the information is still modest for reasonable router tree sizes without compression.

It will be understood that for each flow chart, the depicted steps are provide for purposes of illustration and explanation only, and that the steps may be modified, omitted, or re-ordered, and other steps may be added, without departing from the scope of this disclosure. While the foregoing drawings and description set forth functional aspects of the disclosed systems, no particular arrangement of software and/or hardware for implementing these functional aspects should be inferred from these descriptions unless explicitly stated or otherwise clear from the context, and all such arrangements of software and/or hardware are intended to fall within the scope of this disclosure.

The methods or processes described herein may in general be realized as a computer program product embodied in a computer readable storage medium that performs the corresponding steps, or as a device including a processor, memory and/or other circuits configured through programming or the like to perform the steps described. Traditionally, a computer program consists of a finite sequence of computational instructions or program instructions. It will be appreciated that a programmable apparatus can receive such a computer program and, by processing the computational instructions thereof, produce a further technical effect. Regardless of the type of computer program or computer involved, a computer program can be loaded onto a computer to produce a particular machine that can perform any and all of the depicted functions. This particular machine provides a means for carrying out any and all of the depicted functions.

A processor or programmable apparatus as described herein may include one or more microprocessors, microcontrollers, embedded microcontrollers, programmable digital signal processors, programmable devices, programmable gate arrays, programmable array logic, memory devices, application specific integrated circuits, quantum computing devices, optical computing devices or the like, which can be suitably employed or configured to process computer program instructions, execute computer logic, store computer data, and so on. A computer or processor as described herein may include a general purpose computer, a special-purpose computer, a programmable data processing apparatus, a processor, and so on as well as any combination of the foregoing.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may more generally include any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, it will be understood that the depicted elements and the functions thereof may be implemented as parts of a monolithic software structure, as standalone software modules, or as modules that employ external routines, code, services, and so forth, or any combination of these. At the same time execution of the depicted processes may be single or multi-threaded and/or configured for execution on one or more processors. All such implementations are within the scope of the present disclosure.

In view of the foregoing, it will be appreciated that elements of the block diagrams and flowchart illustrations support combinations of means for performing the specified functions, combinations of steps for performing the specified functions, computer executable code for performing the specified functions, and so on.

It will be appreciated that computer executable code may include may include any program instructions or the like. A variety of languages for expressing computer program instructions are possible, including without limitation structured programming languages such as C, C++, Java, JavaScript, assembly language, Lisp, and so on. Such languages may also or instead include assembly languages, hardware description languages, database programming languages, functional programming languages, imperative programming languages, structured programming languages, object-oriented programming languages, scripting languages, high-level languages, low-level languages, and so on. In some embodiments, computer program instructions can be stored, compiled, or interpreted to run on a computer, a programmable data processing apparatus, a heterogeneous combination of processors or processor architectures, and so on. Without limitation, embodiments of the present invention can take the form of web-based computer software, which includes client/server software, software-as-a-service, peer-to-peer software, or the like.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

1. A method for wireless communication within a wireless ad hoc network, the method comprising:
identifying criteria and weightings for a multivariate route cost calculation for each of a plurality of traffic types;
identifying possible routes to each destination within a backhaul access point routing domain;
applying the multivariate route cost calculation to determine a lowest-cost route to each destination within the backhaul access point routing domain for each one of the plurality of traffic types thereby providing routing data;
storing the routing data in a routing matrix accessible by traffic type and destination;
identifying a transmit traffic type and a transmit destination for data in a transmit queue;
looking up the lowest-cost route to the transmit destination for the transmit traffic type in the routing matrix; and
transmitting the data to the transmit destination according to the lowest-cost route.

2. The method of claim 1 further comprising updating the routing matrix using a scoped link state routing algorithm.

3. The method of claim 1 wherein the plurality of traffic types includes Voice over Internet Protocol, and wherein the weightings for the multivariate route cost calculation are selected to minimize a number of hops to each transmit destination.

4. The method of claim 1 wherein the plurality of traffic types includes one or more Quality of Service levels.

5. The method of claim 1 wherein the plurality of traffic types includes one or more prioritization levels.

6. The method of claim 1 wherein the plurality of traffic types include one or more of host traffic, voice data, audio download data, streaming video, and binary information.

7. The method of claim 1 wherein the criteria include one or more of a power level, a link quality, a node bandwidth, and a number of hops.

8. The method of claim 1 wherein the criteria include one or more items selected from a group of power usage by a node, mobility of a node, CPU processing requirements, configuration requirements, congestion at certain nodes, and adaptive data rate (ADR) information.

9. The method of claim 1 wherein the weighting for one or more of the criteria is chosen by a user.

10. The method of claim 1 wherein the transmit destination includes a backhaul access point for any destination outside the backhaul access point routing domain.

11. A node in a wireless ad hoc network comprising:
a data source;
a radio for operating within the wireless ad hoc network;
a memory for storing routing information; and
a processor programmed to identify criteria and weightings for a multivariate route cost calculation for each of a plurality of traffic types; identify possible routes to each destination within a backhaul access point routing domain; apply the multivariate route cost calculation to determine a lowest-cost route to each destination within the backhaul access point routing domain for each one of the plurality of traffic types thereby providing routing data; store the routing data in a routing matrix accessible by traffic type and destination; identify a transmit traffic type and a transmit destination for data in a transmit queue; look up the lowest-cost route to the transmit destination for the transmit traffic type in the routing matrix; and transmit the data to the transmit destination according to the lowest-cost route.

12. The node of claim 11 wherein the processor is further programmed to update the routing matrix using a scoped link state routing algorithm.

13. The node of claim 11 wherein the plurality of traffic types includes Voice over Internet Protocol, and wherein the weightings for the multivariate route cost calculation are selected to minimize a number of hops to each transmit destination.

14. The node of claim 11 wherein the plurality of traffic types includes one or more Quality of Service levels.

15. The node of claim 11 wherein the plurality of traffic types includes one or more prioritization levels.

16. The node of claim 11 wherein the plurality of traffic types include one or more of host traffic, voice data, audio download data, streaming video, and binary information.

17. The node of claim 11 wherein the criteria include one or more of a power level, a link quality, a node bandwidth, and a number of hops.

18. The node of claim 11 wherein the criteria include one or more items selected from a group of power usage by a node, mobility of a node, CPU processing requirements, configuration requirements, congestion at certain nodes, and adaptive data rate (ADR) information.

19. The node of claim 11 wherein weight for one or more of the criteria is chosen by a user.

20. The node of claim 11 wherein the transmit destination includes a backhaul access point for any destination outside the backhaul access point routing domain.

21-124. (canceled)
